(19) United States
(12) Patent Application Publication
(10) Pub. No.: US 2002/0120582 A1
(43) Pub. Date: Aug. 29, 2002

(54) Method for establishing an electronic commerce account

(76) Inventors: Stephen Elston, Seattle, WA (US); Brent Bolleman, Redmond, WA (US); Barry Smith, Kirkland, WA (US); Kevin G. Brown, Seattle, WA (US); Jeri M. Goldberg, Seattle, WA (US); David H. Edelstein, Seattle, WA (US)

Correspondence Address: Dr. Stephen Elston,, ONTAIN CORPORATION, Suite C-245, 1750 - 112th Avenue NE, Bellevue, WA, 98004, US

(21) Appl. No.: 10/087,364

(22) Filed: Mar. 4, 2002

Related U.S. Application Data
(60) Provisional application No. 60/271,347, filed on Feb. 26, 2001.

(51) Int. Cl. G06F 17/60; H04K 1/00; H04L 9/00

(52) U.S. Cl. 705/64; 705/39

(57) ABSTRACT

In an electronic remote ordering system, an initial order from a new customer may be processed using limited information, with activation of the customer account, possibly including a payment account, occurring upon the customer's attendance at a customer-specified merchant point of sale for order fulfillment. Activation of the accounts may be upon obtaining a contract signature from the customer and/or in person verification of the customer's identity at the point of sale. Payment account information may be secured remotely or upon attendance at the point of sale. In the latter case, payment account information can be electronically captured from the means of payment tendered by the customer. The invention eases the burden on new customers and allows effective authentication during account creation.

### RELATED APPLICATIONS

This application is a continuation in part of co-pending U.S. patent application (application number not yet assigned) filed Feb. 4, 2002 entitled Remote Ordering System for Mobile Commerce and claims the benefit under 35 U.S.C. 119(e) of earlier filed U.S. Provisional Application No. 60/271,347, filed Feb. 26, 2001.

### FIELD OF THE INVENTION

This invention relates to establishing customer accounts in electronic remote ordering systems, including mobile commerce systems. In particular this invention relates to establishing customer accounts in such systems wherein order fulfillment is by attendance of a customer at a physical merchant location.

### BACKGROUND OF THE INVENTION

Electronic commerce and mobile commerce have not experienced the adoption rates once predicted. One barrier to adoption is the burden placed on prospective customers of creating and maintaining the required mobile commerce account. Another barrier is the lack of transaction security to prevent customer repudiation of transactions for the most common and economical forms of payment. In addition, electronic and mobile commerce schemes that require merchants and customers to adopt new technology generally take a long time to achieve a critical mass of penetration.

A customer mobile or electronic commerce account should be usable for remote ordering of goods and services, and include identity information, security information, payment account information and ordering information for the merchant locations of interest. In prior art systems, account information is either entered before the customer attends at the merchant's location or is acquired in real-time as the customer places the remote order and effects a payment operation. There is often no means for the merchant or the customer to verify the other's identity in a timely and economical manner.

It is usually the merchant who bears the risk of poor authentication. Because of such risk, merchants may not be in a position to accept certain types of payments at all, having regard to regulatory restrictions, or to the rules of payment associations, acquiring financial institutions, and payment processors. The risk of repudiation is aggravated by the fact that simply pushing an “I agree” button in a browser, or similar methods commonly used in electronic commerce, does not provide protection against later repudiation of the transaction by the customer, for example because a payment by credit card is still considered a “card not present” transaction.

These payment risks are material for electronic commerce merchants resulting in paying high interchange rates, fees, or needing to pay additional fees to payment guarantee services. Interchange rates and fees paid by merchants are almost always lower for “card present” transactions or other transactions where the merchant can verify the customer's identity and collect a signature on a payment agreement. For example, in the United States consumer protection regulatory restrictions make it difficult if not impossible for merchants to use low-cost debit payments, such as Automatic Clearing House (ACH) transactions without a previously signed contract with the customer. Processing contact documents, with signatures, through means such as the mail is clearly inconvenient for both merchants and customers, and can be a detriment to use of a remote ordering system.

Current practice also does not provide the customer with protection against unauthorized use of their payment account.

Prior art electronic commerce industry security standards either provide weak authentication or are difficult to implement and use. The well-known and widely used Secure Socket Layer (SSL) standard, promulgated by Netscape (www.netscape.com/eng/ssl3), or the related Wireless SSL (WSSL) standard are easy to use and provides cryptographically strong security, but merchants and customers cannot authenticate one another.

Industry groups have also published standards for electronic transactions specific to mobile commerce. The Mobile Electronic Transaction Forum (MeT) (www.mobiletransaction.org) has published a complete framework for customer interfaces, transaction communication protocols and security for mobile electronic commerce. The Mobile Payment Forum (www.mobilepaymentforum.org) and the now defunct Radicchio (www.radicchio.org) each published security standards for mobile electronic commerce transactions. Yet all such systems require customers, telecom operators and in some cases merchants to deploy special technology (typically based on smart cards or electronic security certificates) and the processes involved do not improve customer convenience. Further, these standards do not enable the direct authentication of customers for the benefit of the merchant, nor do they make the system easier to use for customers.

The financial services/payment industry has also made attempts to facilitate electronic commerce and mobile commerce. The Visa payment association has developed the Secure Electronic Transaction (SET) and 3D SET (www.setco.org) standards. These technologies allow customers to be authenticated to merchants through the customer's financial institutions and protect merchants from transaction repudiation. However, they have not found favor with merchants, customers or financial institutions because of the complexity of the technology required, which reduces convenience for both merchants and customers.

The National Automatic Clearing House Association (NACHA) publishes operating rules in the United States for Electronic Funds Transfer (EFT). The NACHA Operating Rules document and electronic commerce risk management document (Risk Management for the New Generations of ACH Payments: Internet, Electronic Check, and Telephone Payments) stipulate that a contract be signed by a customer before payments for electronic commerce can be made, particularly for the WEB debit entry type. The suggested “best practice” is to send this contract through the mail, making the process slow and running counter to the real-time nature of electronic and mobile commerce since it delays account activation. Further, there is no simple way for a merchant to verify a customer's identity. To improve this situation NACHA has undertaken Project Action (ACH Credit Transactions Initiated Online) to improve the security of online EFT transactions. However, customers are still required to go through a lengthy registration process and require a special security certificate or smart card.

U.S. Pat. No. 4,960,981 to Benton and Mee describes an attempt to overcome the problem of timeliness of EFT account activation by using faxed forms. However, this system has limited security capability and requires merchants and customers to have access to fax machines or fax servers.

Attempts have also been made to facilitate electronic commerce through the use of electronic wallet systems allowing customers to set up a single set of payment accounts, which can be used with multiple merchants and do not require any special technology on the part of the customer. Companies such as iPIN (www.iPIN.com), QPASS (www.qpass.com) and Microsoft through their Passport service (www.passport.com) as well as others have introduced electronic wallet services. All of these services require the customer to enter a significant amount of information to set up an account and all lack a method to authenticate the customer or incorporate capabilities to prevent the repudiation of transactions by customers.

A system developed by Paybox (http://www.paybox.de/international/english.html) and discussed in WO 0046768 to Entenmann relies on telephone network security, particularly that of the GSM system. While convenient for the customer, this system requires the merchants to have business relationships with multiple telecommunications carriers to prevent transaction repudiation. When the system is extended to other types of telecommunications, network security is reduced.

A system developed by PayPal (www.paypal.com) and described in WO 0205224 to Templeton and Bhargava and WO 0205231 to Sacks uses a scheme to authenticate the customer and verify that the customer is the legitimate holder of a payment account. While this system is both reasonably secure and simple to use, account activation is not conducted in real-time.

Prior art electronic commerce systems and mobile commerce systems, including those described in U.S. Pat. No. 5,991,739 to Cupps and Glass, U.S. Pat. No. 6,026,375 to Hall et. al., WO 00/45312 to Bigus, U.S. Pat. No. 5,710,887 to Ramen et. al. WO 01/25985 to Djupsjobacka et. al. WO 01/3298 to Dodson and Howe, WO 00/68859 to Borders et. al.), and EP 1 016 999 to Ogasawara, require a customer to enter full payment account information and browse extensive menus to select goods and services of interest to complete transactions. These systems provide various forms of preference or shopping list management to assist the customer with subsequent transactions, but such features are not available for the initial account setup. Further, these systems provide no method to authenticate the identity of the customer.

Verifiable and trusted electronic payment is a required component of a fully capable electronic commerce system. The lack of such capability, the requirement to use processes requiring additional technology or complex operations on the part of the customer or merchant, and the failure to enable the activation of payment accounts in real time all discourage the use of electronic commerce by both customers and merchants.

The present invention finds application in mobile and electronic commerce systems wherein order fulfillment is accomplished by the customer's attendance at a physical merchant location. One of the objects of the invention is to provide a reliable means of authenticating a customer in such a system wherein the merchant can secure a signed contract or other reliable commitment instrument from the customer.

Another object of the invention is to provide a reliable means of creating a customer account while minimizing the inconvenience to the customer.

A further object of the invention is to provide a mobile or electronic commerce system that accommodates various levels of customer accounts, having regard to the amount of customer-related information collected from the customer and that accommodates corresponding levels of payment capabilities.

These and other objects of the invention will be more fully appreciated by reference to the following disclosure and claims.

### SUMMARY OF THE INVENTION

The invention finds application in mobile and electronic commerce systems wherein order fulfillment is accomplished by the customer's attendance at a physical merchant location, for example to pick up an order placed remotely and directed to the specific merchant location.

The invention has a number of aspects the implementation of which is enabled by a suitably configured remote ordering system used in association with in-person order fulfillment at customer-specified merchant locations.

According to one aspect of the invention, a customer account is provisionally created when a new customer accesses the remote ordering system. The remote ordering system allows the new customer to remotely place an initial order. The remote ordering system processes the order through to the merchant location for fulfillment. Activation of the customer account (for the purpose of completing the initial transaction, or for the purpose of enabling future transactions) is deferred until the customer attends at the merchant location to receive order fulfillment, at which time the signature of the customer is obtained in respect of a contract, or a summary thereof, governing the use of the remote ordering system.

Upon the customer attending at the merchant location for fulfillment of an initial order placed remotely through a remote ordering system, the customer's identity may also be verified in person in addition to obtaining the signature of the customer is also obtained in respect of a contract governing the use of the remote ordering system.

The foregoing aspects of the invention minimize the risks associated with initial or recurring payment from a non-authenticated customer. By securing a signed contract at the point of sale of the initial order, the invention provides a convenient mechanism for customers to authorize a merchant to use an ACH debit to the customer's Demand Deposit Account (DDA) using a WEB debit entry or similar payment type. This also provides a way for merchants and customers to initiate a trusted relationship. Once a contract has been signed and the trust conditions between the merchant and customer have been established, the customer can carry out a series of secure transactions with the merchant under the terms and conditions set forth in the contract. The subsequent transactions conducted using the trust relationship can include the establishment of additional payment accounts or separate transactions to fund or make payment on an existing account.

The signature can be used to verify the identity of the customer when checked against identification (typically photo identification is verified at point of sale). In addition, a signature provides a merchant, payment processor or service provider “proof” of customer consent in cases where the customer attempts to repudiate the transaction. The initial payment is made once the signature on the contract and the validation of the customer has been completed. The signed contract and authentication information is stored and is then used as the basis for subsequent transactions using the remote order system.

According to the invention, a customer may register an electronic security credential, which can then be used as a digital signature for subsequent payment transactions. Registration is performed in the presence of the merchant and is therefore authenticated by the merchant. The authentication credentials or digital signature in many cases will be attached or associated with the customer's wireless device. In other cases, the credential or signature will be attached or associated to a computer (i.e. a PC) or a telephone. It should be noted that the invention does not require the device carrying the electronic credential or used for providing digital signature to be physically present at the point of sale and that a piece of shared secret information can be used as a surrogate. Authenticating the customer against this shared secret information serves the same purpose as using any other security credential or signature method at the point of sale.

In the context of this invention, a digital signature is defined as any electronic credential that a user can present to a merchant or system operator to verify their identity. Numerous electronic authentication or security credential methods for electronic payment have been proposed and a number of these technologies have been put to use. Typically shared secret information includes a password (including Personal Identification Number or PIN) and often combined with a user name or other identifier. Other suitable security credentials include biometric identification (including retinal scans, fingerprints and voiceprints), Public Key Infrastructure (PKI) certificates, and shared secret key cryptographic certificates.

Alternatively, the contact and shared secret security data could be between the customer and a third party service provider. In this case a merchant acts as a facilitator or agent, activating the customer's account and verifying their identity. The third party service provider can then provide the customer with the ability to conduct secure transactions with merchants or other customers with whom the service provider has a relationship under the terms and conditions set forth in the contract. The process of establishing the verified trusted relationship with the customer is the same in any case.

The security of a signed customer contract with verification of customer identity can be of great benefit to both merchants and customers and can enable many types of electronic payment services including:

1. micro-payments for digital content or other low value purchases such as at vending machines,

2. using telecommunications billing systems to pay for purchases of goods and services,

3. funding of prepaid telephone or other service accounts,

4. electronic payment of bills,

5. automated payment for fuel, other self service products or customer self checkout,

6. providing the customer the ability to perform order and payment operations within a chain of affiliated merchants, and

7. giving customers the ability to make payments to each other's accounts, a process often referred to as Person to Person (P to P) payments.

The merchant may also act as an agent for third party providers of the foregoing services or products, relying on the trust relationship built up with the customer to complete transactions involving such third party services or products.

A system operator or payment processor would typically operate the system offering such services. The signed contract or service agreement between the customer and the operator would include terms required for these applications.

In another aspect of the invention, a customer account is provisionally created when a new customer accesses the remote ordering system. The remote ordering system allows the new customer to remotely place an initial order. A customer identifier, which may be an arbitrary user name, is determined. The remote ordering system creates a provisional customer account and, without immediately arranging for payment, processes the order to the merchant for fulfillment. Upon the customer's later attendance at the merchant location to pick up the order, the customer is identified to the merchant using the customer identifier and a form of substantially anonymous payment (such as cash) is secured from the customer. Upon payment for said order at said merchant location, the customer account is activated, using the customer identifier. In a further aspect of the invention, upon the customer attending at the merchant location for fulfillment of the order, the customer's identity is obtained and verified in person and the customer's signature is obtained in respect of a contract governing use of the remote ordering system.

In yet another aspect of the invention, upon the customer's attendance at the merchant location to pick up the order, the customer is identified to the merchant using the customer identifier and information required to establish a payment account is obtained in relation to the customer. The payment account may be any form of payment account requiring electronic processing, including a stored value account, a debit account, a credit account, etc.

Some of the information required to establish the payment account is obtained by electronically capturing information from means of payment or a payment credential tendered by the customer to the merchant at the point of sale, thereby enabling the creation of a more complete customer account. Relevant payment account information can be read from magnetic cards, smart cards, check drafts or other payment instruments, saving the customer the effort and potential errors of manually entering or orally providing this information.

Alternatively, the information is obtained by the customer providing the information by direct entry, in writing or orally, at the point of sale.

In yet another alternative, the information is obtained from marketing databases containing likely customer prospects.

In a further aspect of the foregoing, the customer account is only activated after the customer's signature is obtained in respect of a contract governing the customer's use of the remote ordering system. In yet a further aspect, the customer's identity is also verified in person.

In the foregoing embodiments, the customer account is provisionally created contemporaneously with the placing of the initial order, but although the initial order is processed for fulfillment, the account is only activated following the customer's attendance at the physical merchant location to receive order fulfillment and to effect payment. More specifically, in the embodiments described above, the customer account is activated upon receiving cash or other anonymous payment, upon capture of additional information from means presented at the point of sale, or upon obtaining a signature on a contract. It will be appreciated that the moment of activation may be somewhat delayed, for example upon receipt of on-line payment authorization, upon settlement, upon later approval of the written contract, upon later verification of a digital signature, etc.

By completing activation of the account upon the customer's attendance at the point of sale, the invention provides a means for merchants to directly verify and authenticate the identity of customer before the first transaction is completed.

In another aspect of the invention, a customer attends at a specific merchant location served by a remote ordering system to place an in-person order. According to this aspect of the invention, the customer is invited to establish a customer account for the remote ordering system, and the customer's signature is obtained in respect of a contract governing use of the remote ordering system. In a further aspect, the customer's identity is also verified in person.

In a related aspect of the invention, information relating to the customer's initial order is captured from a POS terminal associated with the merchant to populate preferences in the customer's account.

In a further related aspect, a payment account is established by collecting information. The information may be obtained from the customer orally, in writing or by direct entry by the customer. Alternatively, some of the information may be electronically captured from the means of payment or a payment credential tendered by the customer at the point of sale. In a further alternative, the information may be obtained from a marketing database containing identifying information regarding customer prospects.

The invention allows customers to create different levels of accounts with different capabilities. A customer benefits from being able to use a substantially anonymous account and can subsequently upgrade the account by adding more information as the need arises. Thus, customers can conveniently increase the capability of the account (for example when the service and merchant are considered to be sufficiently trustworthy). The following levels of customer account and associated capability are contemplated by the invention:

1. A substantially anonymous account enabling the customer to order goods and services. Despite the substantial anonymity, the account may be associated with electronically stored ordering preferences. The remote orders are paid for at the point of sale.

2. A substantially anonymous account enabling the customer to order goods and services, offering electronically stored ordering preferences as well as payment through a substantially anonymous stored value account, funded from time to time at the point of sale.

3. A full capability remote ordering account enabling the customer to order goods and services, offering electronically stored ordering preferences, and using electronic payment from electronically stored account information.

To further improve customer convenience the invention makes maximum use of information that can be collected through minimal direct effort on the part of the customer before the first remote order and payment transaction can be completed. This allows an initial order for a new customer to be processed without delay. Additional information, if required for the type of customer or payment account desired, can conveniently be captured during the payment transaction for the initial order, thereby reducing the burden on the customer.

In one of its aspects, the invention also contemplates both the creation and activation of a customer account following the placing of an order at a merchant location. According to this aspect, a customer who attends at a merchant location and has placed an order in person may be invited by store personnel to open an account to allow future orders to be placed remotely. The order data from the customer's order may be captured by an integrated POS system and combined with identifying information provided by the customer, for example a telephone number, to create and activate an account for future use. The account may be of the substantially anonymous types described above or the fully capable type with electronic payment capability. In either case, a contract may be presented to the customer at the point of sale for signing and the customer's identity can be verified in person.

The integration of a remote ordering system with physical merchant locations at which orders are fulfilled in person makes the features of the invention feasible, including the identity verification in person at the point of sale, obtaining a signed contract, allowing provisional customer accounts to be created with completion of customer or payment account information at the point of sale, as well as the other features identified herein.

It will be appreciated that the foregoing statements of the features of the invention are not intended as exhaustive or limiting, the proper scope thereof being appreciated by reference to this entire disclosure and to the substance of the claims.

### BRIEF DESCRIPTION OF THE DRAWINGS

The preferred and alternative embodiments of the invention will be described by reference to the drawings thereof in which:

FIG. 1 is a diagrammatic view of the remote ordering system used in association with the preferred embodiment of the invention;

FIGS. 2A and 2B are a flowchart of a remote customer account creation process according to the preferred embodiment;

FIGS. 3A and 3B are a flowchart of an in-store customer account creation process according to the preferred embodiment;

FIGS. 4A to 4D are a flowchart of a customer account activation process according to the preferred embodiment;

FIGS. 5A to 5D are a flowchart of a recurring payment process according to the preferred embodiment;

FIGS. 6A to 6N are a flowchart of an in-store order process according to the preferred embodiment; and,

FIGS. 7A to 7H are a flowchart of a telephone order process according to the preferred embodiment.

### DETAILED DESCRIPTION OF THE PREFERRED AND ALTERNATIVE EMBODIMENTS

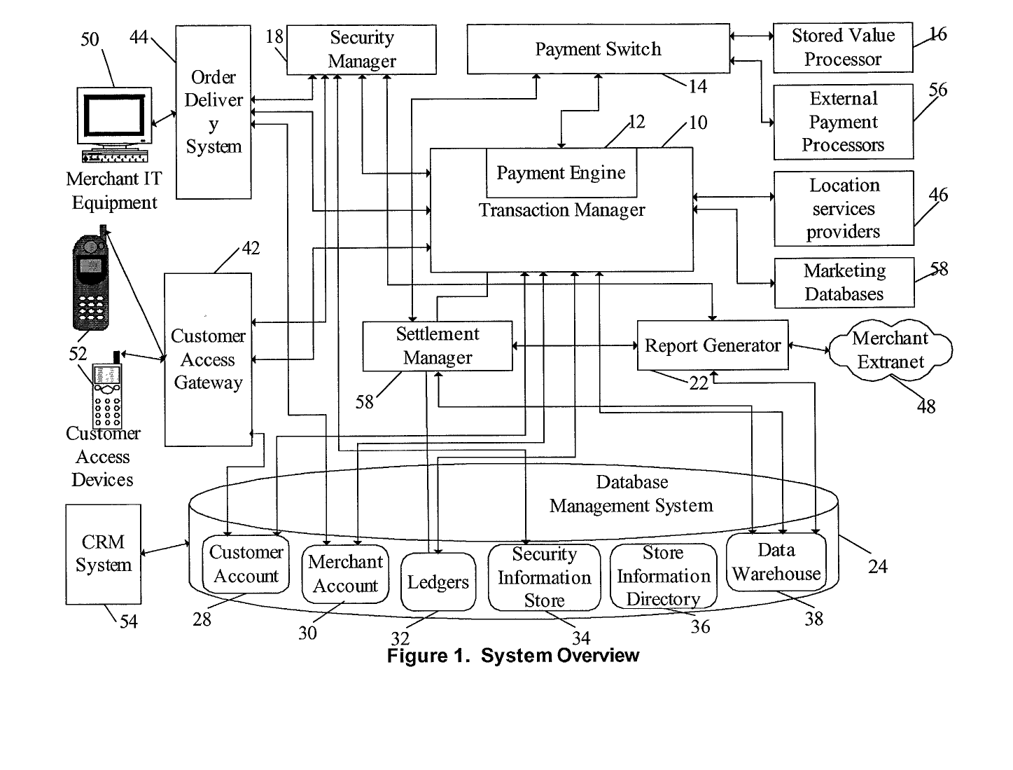

The preferred embodiment of the invention is used to facilitate transactions with remote ordering customers wishing to place orders and make payment for fulfillment and pick up at one of several merchant locations. The remote ordering customer interfaces with the remote ordering system, which is implemented through one or more servers, and places the order with the system by means of a mobile wireless device or other electronic interface device. The major system components of the remote ordering (“RO”) system used in the preferred embodiment of the invention are illustrated in FIG. 1. The RO system is based on the remote ordering system described herein and further detailed in our co-pending U.S. patent application (application number not yet assigned) filed Feb. 4, 2002 entitled Remote Ordering System for Mobile Commerce. However it will be appreciated that many aspects of the invention are equally applicable to other embodiments of remote ordering systems that might be contemplated for use in conjunction with order fulfillment at physical merchant locations.

The major system components of the preferred embodiment include:

Transaction manager 10

Payment engine 12

Payment switch 14

Stored value processor 16

Security manager 18

Settlement manager 20

Report generator 22

Database 24 and a database management system

Order delivery system 40

Customer access gateway 42

The database 24 resides in non-volatile storage such as hard disk drives and includes:

Customer accounts 28

Merchant accounts 30

Transaction ledgers 32

Security information store 34

Store information directory 36

Data warehouse 38

Not all of the components are necessary to the functioning of the invention. For example, a stored value processor 16 is desirable to facilitate payment, but such a payment option may not be critical to all embodiments of the invention.

The principal components identified above are preferably housed and executed on one or more servers dedicated to the RO system of the invention and remote from the merchant store locations. Many of the components may be implemented as distributed sub-systems.

External components interfaced to the RO system include:

External payment processors 56

Location service providers 46

Merchant extranet 48

Merchant IT equipment 50

Customer access devices 52

CRM system 54

Marketing Databases 58.

A summary of the interaction between these components is first presented in this section.

The database 24 includes information specific to each merchant location, and organized in a structure that reflects the organizational structure and hierarchy of the merchant organization. This allows merchant-location specific functionality to be implemented in the RO system, which in turn allows customers to place orders with any one of the group of affiliated merchants serviced by the RO system.

Each merchant location is further associated with a merchant account 30 allowing the RO system to tailor various remote ordering and post-sale processes to the rules and conditions applicable to that merchant location.

Summary of Interaction of Components of the RO System

The following is an overview of the functions of the main components or subsystems of the RO system.

The transaction manager 10 controls the overall transaction flow and executes the required business logic. The transaction manager uses the services of the other components of the RO system, including the security manager 18, the payment engine 12, and the order delivery system 44.

The payment engine 12 computes the price, promotional value, tip, fees and taxes under the control of the transaction manager 10. The payment engine receives payment authorization from either the internal stored value processor 16 or external payment processors 56 through the use of a payment switch 14.

The security manager 18 controls all access to data, reports and system services for the RO system, including access for both merchant employees and customers. The report generator 22 provides merchant personnel with reports on RO transactions from the data warehouse 38 and under the control of the security manager 18. The security manager uses a set a security protocol adaptors to accommodate the authentication protocols used by the various merchant and customer connections to the system. For data or system service access for personnel the merchant account security manager (18) authenticates the person and determines the permissions for data and service access. Authentication is done when personnel access the RO system over the merchant extranet (48) or through terminal or POS equipment (50) at a store location. If personnel attempt to access data or services for which they are not authorized the merchant account security manager (18) will prevent them from doing so.

The transaction manager 10, payment engine 12 and security manager 18 each make use of the records maintained in the database 24. This information includes the customer and merchant account information, store information directory 36 for each store location and for groups of locations, and security access and authentication information in the security information store (34). Certain transaction records are maintained in ledgers 32 and an archive of transaction details is maintained in the data warehouse 38.

The RO system is adapted for use in association with a chain of affiliated merchants, for example in a franchise group. A security information directory and/or a store information directory are maintained wherein merchant location-specific information is retained to allow the remote ordering system to be used seamlessly across the various merchant locations in the chain. Such information includes for example information relating to order fulfillment capability, payment accounts, settlement protocols, menus, rules and administrative privileges.

For affiliated chains of merchants the security information store (34) is organized in a hierarchical manner. Merchant brands are divided into administrative groups that are generally organized along corporate organizational lines. A merchant brand can be divided into one or more geographic divisions and the geographic divisions divided into one or more geographic subdivisions. These subdivisions can include the territory of an individual franchise operator. There can be multiple levels of geographic subdivisions as required by corporate organizational structure. Geographic divisions or subdivisions are divided into individual store locations (518). Merchant employees and RO system administrators are organized into functions or “roles” that are used to simplify administration of permissions (for example to authorize refunds or to change merchant account information). These permissions are set through an administrative interface. Merchant employee permissions and roles are organized hierarchically in a manner that reflects corporate and ownership structure. Examples of levels in this hierarchy may include:

1. Corporate,

2. Geographic division or region,

3. Group of store or franchise group,

4. Store employees.

Roles within these levels include:

1. Financial manager,

2. Marketing or product manager,

3. Operations manager,

4. Franchise owner,

5. Store manager, and

6. Store employee.

The security administration interface itself contains a hierarchy of security administration authority. Different levels within an organization can set the permissions and create accounts for personnel within their part of the company. Generally, security administrators can create or delete accounts for their level in the hierarchy or below. Thus, control of the administrative function is itself hierarchical. As an example, administrators at a corporate level can set permissions for corporate employees at the corporate, regional or divisional level. Administrators at the regional or divisional level can set permissions for personnel within that division or region including store managers, franchisees or store owners. Administrators at the store or franchisee level can set permission for personnel directly associated with that store or stores. Levels and authorities for company-owned stores within a chain are generally structured differently than for franchisee-owned stores. The security administration interface is used to create or delete new merchant employee and store location accounts. Generally, security administrators can create or delete accounts for their level in the hierarchy or below. For example, administrators at the store or franchise level will create or delete store employee accounts.

The store information directory (36) is also organized in a hierarchical manner. To allow customers to accurately remotely order and pay for goods and services agreement is required between the items, prices, promotional offers, service fees, and taxes offered at each specific store location and those shown in the RO system store information directory. The benefits of remote ordering are defeated if items shown in the store information directory are not actually available at the store, or items desired by the customer are not listed in the store information directory. To ensure the store information directory has the desired content for each store location from time to time it can either be automatically synchronized with the store's POS system or administered manually or some combination of both. Nonetheless, the prices posted for the mobile commerce system need not necessarily be the same as those available in the store, but in general they are based on those prices. For example, the merchant may assess a surcharge or service fee. Alternatively, the merchant may offer discounts to encourage potentially lower cost electronic orders. Merchants in chains of associated stores are generally organized into an overall brand or brands (a corporate entity can own more than one brand), geographic regions or sub-regions, groups of stores (including franchisee-owned groups) and individual stores. As discussed below, the store information directory 36 and the administration authority reflects such organizational structures.

Within chains or merchant brands, geographic divisions, and subdivisions contain master menus or submenus. The use of these master menus simplifies the administration of the overall store information directory (36), by reflecting the authority or administration structure in the directory. Attributes and rules (required items, price ranges, item or category names, etc.) can be enforced from one level to the next as required. These master menus can contain information used in menus lower in the hierarchy. Using these master menus can thus speed directory administration at lower levels. Examples of global or regional attributes and rules include the following, a) the name of the chain or brand, b) brand or region wide promotions, c) logos or trademarks, d) policy statements, e) terms and conditions for customer use of the RO system, f) transaction or service fees, g) Frequently Asked Questions (FAQs), h) service fees, and ih) display templates and objects for the brand or geographic region. To aid in administration and organizations levels in the hierarchical directory structure can be multiply linked to other levels beyond the ones immediately above and below. For example, attributes in a master menu can affect items at several levels:

1. The entire directory or menu,

2. A specific menu or sub-menu,

3. A type or category of items,

4. Required or non-required options for a type of category of items or compound items,

5. Specific items, and

6. Required or non-required options for a type of category of items or compound items.

The customer account (28) includes all information required by the system to allow the customers to place orders and make payments. The customer account (28) contains the payment account information organized by chain as well as for independent store locations. The customer account (28) includes information (or links to information in other database records) to identify (ID) customers and their access devices. Preferably, these data will include:

1. A unique account number,

2. User name or alias used for account access,

3. payment wallet containing electronic payment account information as required,

4. Identity information and information on identity verification (shared secret information, signatures, etc.),

5. Telephone number or other device identifiers, and

6. Device type or capability information including device ID such as IP address, device capabilities for display, security, etc, and links to security information stored in the security information store (34).

The customer account (28) includes a payment wallet containing all available payment account information in one or more purses. This payment information can generally include stored cash value purses (i.e. a prepaid account), promotional value purses or direct and payment account data. One or more cash purses (if present) contain information on the value in the account, the account used to electronically add funds (if desired by the customer) to the stored value purse and a list of the merchants or merchant chains accepting the account.

The merchant account (30) contains all information, or links to other data storage, required for a store location to accept remote order and payment transactions and perform settlement through the RO system. The merchant location can be a part of a chain of affiliated merchants or a single stand-alone location. A separate merchant account is required for each store location in either case. The merchant account (30) contains basic store information including a store number of other identifier, the store name or location name. The account also contains the geographic or other company divisions the store is associated with, and one or more brand identifiers associated with the store. The merchant account contains (or has links to) one or more financial account records showing all transactions at that store location and preferably including:

1. The merchant account number for that account,

2. The type (settlement, promotional, etc) of account,

3. The account owner, or merchant of record,

4. The current settlement balance for that account,

5. The financial institution holding the Demand Deposit Account, and

6. The transaction history (or links to the ledger system) for that account,

7. Links to the specific store information directory (36),

8. Links to the security information store (34) for the employees at the store location,

9. Account contact information, including the name of the account owner or primary contact, the contact telephone number, the contact's email address, the mailing address, and alternative contact information as may be required, and

10. The payment types and customer authorizations accepted by the merchant location, and any authorization rules, such as value limits, need for signature capture, etc, for that payment type.

The settlement processor 20 creates financial settlement files for each store location using the service. These files are transmitted at required time intervals through the payment switch (14) to the appropriate payment processors (56), who then settle funds to each merchants demand deposit account. In general each store location of a chain of merchant will have individual demand deposit accounts and will be settled separately.

Customers using various types of wireless and fixed wired devices 52 to access the services of the RO system through the customer access gateway 42.

The CRM system 54 is used to perform customer support and relationship management functions using the records in the database, including the customer account 28 and data warehouse 38. The CRM system can be operated by a variety of entities including the RO system service provider, a financial institution or the merchants themselves.

External Components

The RO system can use one or more external payment providers 56. The services of these providers can include multiple payment types including credit, debit, and stored value.

One or more location service providers 46 are used to provide store location services and location directions for customers. These services allow customers using the RO system to find merchant locations of interest or to find the most convenient location of a chain merchant.

The merchant employees use the merchant extranet (48) to access reports created by the report generator (22) and administer the RO system. Access to the extranet can be through the Internet, telephone, or other suitable means.

The order delivery system 40 transmits and confirms orders to the merchant IT equipment 50 at each individual store location. The merchant IT equipment (50) can include a variety of systems at the store location or distributed to remote data centers including, payment terminals, terminals dedicated to the RO function, integrated POS systems, self-service kiosks and associated peripherals. These systems communicate with the RO system through the order delivery system 44.

External marketing databases (58) are used as sources of information to pre-populate prospective customer accounts or to target prospective customers who are likely to be interested in using the remote ordering service.

Customers can access the services of the RO system using a wide variety of wireless and fixed wired devices 52, including telephones, text messaging devices and Internet terminals connecting to the customer access gateway 42.

Distributed Components

The RO system may be distributed between multiple locations and entities. Even individual components, including those shown in FIG. 1, may themselves be partitioned and distributed. For example, the customer access gateway 42 may be partitioned between any combination of telecommunications carriers and Internet Service Providers (ISPs). In another example, the security manager 18 may be under the control of and reside within a number of entities such as telecom carriers, ISPs and merchant or third party data centers. The database 24 may also be distributed such that different data tables (customer account 28, merchant account 30, store information directory 36) are under the control of various entities supporting the remote ordering service, such as ISPs, telecommunication carriers, banks, etc. In some cases, it might also be desirable to have, for example a directory of product offerings, that resides on some combination of merchant IT systems 50 at individual stores, centralized merchant data centers and the RO system service contractor.

Payment Account Processing

Electronic commerce requires payment that is secure for both the merchant and the customer. Payment can be electronic or cash at a merchant point of sale or electronic from a remote location.

The payment account is a component of the customer account (28), but is required only for customer accounts relying on electronic payment. A semi-anonymous account using stored value funded at the POS will only require minimal payment account information. Customers paying for purchases at the POS do not require any information in their payment account.

Generally, a customer wishing to use a mobile payment account establishes it either when opening a customer account, or at some later time when the customer wishes to extend the available payment options.

Establishing the payment account may be done electronically from a remote location using an access device (52) connected through the customer access gateway (42) using one of a number of interface adaptors including:

1. an Interactive Voice Response (IVR) interface or speech interface using an Automatic Speech Recognition (ASR) system,

2. through a web browser either on a wireless device or a fixed device,

3. a two-way pager or Short Message Service (SMS) device or Instant Messaging (IM) system, or

4. using a terminal device or kiosk at the merchant's point of sale.

Part of establishing a payment account for stored value payments, credit payments or debit payments will usually be to establish a shared secret between the merchant (or remote ordering system) and the customer. The customer subsequently uses this shared secret to verify their identity when using such payment accounts. The shared secret is usually selected by the customer but may be automatically assigned to the customer by the remote ordering system.

In one embodiment of the invention, during the customer account establishment process in connection with placing an initial order, the customer supplies a minimum amount of personal information along with payment account information, and including a shared secret. The merchant subsequently presents a customer contract to the customer for signing when the customer attends at the POS for order fulfillment. This also provides an opportunity for the merchant to authenticate the customer and to allow the customer and its associated payment account to be activated. Authentication may be by verifying photo identification, requiring production of the credit or other card used for payment, or by some other means.

Electronic generation of a customer contract on the merchant terminal or POS system (50) under control of the RO system is generally triggered by the customer's initial use an electronic payment account to pay for an order with the merchant. When the customer attends at the POS to receive fulfillment of this order, the shared secret is exchanged between the merchant and customer using the terminal or POS system to complete the payment transaction. Once established and verified, the security manager 18 uses the shared secret information as a rapid way to verify the customer's identity as required for electronic payment transactions. For example, the customer can be allowed to place orders, pay for them with a stored value account and have them fulfilled without entering the shared secret information, but may be required to use the shared secret information for direct payments or electronically funding the stored value account.

The present invention provides for the use of a wide variety of shared secret information and electronic security credentials that are suitable for authentication of the customer during recurring payment transactions. For every transaction the security manager (18) authenticates the customer before the transaction is allowed to proceed. The security manager uses a series of security protocol adaptors to support a variety of authentication methods and customer interface devices 52, all accessed through the customer access gateway 42. Those skilled in the art will be familiar with current and emerging methods used to collect and process shared secret information in the payment industry.

In general, passwords, including Personal Identification Numbers (PIN), can be entered as alphanumeric characters into an Internet terminal device (52) (connected to the customer access gateway 42), payment terminal or POS terminal (connected to the order delivery system 44), or can be entered into a telephone (connected through the customer access gateway 42) and decoded using an Interactive Voice Response (IVR) or spoken and decoded with an Automatic Speech Recognition system.

Alternatively, electronic security credentials can be used. These credentials can use symmetric or non-symmetric Public Key Infrastructure (PKI), a hash of an account number or other account identifier with a PIN or password, or symmetric or asymmetric secret key cryptography. These credentials can be contained within various types of customer controlled electronic devices (52), including wired and wireless Internet devices, wired or wireless telephone devices, Radio Frequency Identification (RFID) devices, magnetic cards, or smart cards. These electronic credentials typically require the customer to enter a password or PIN to complete the authorization. In these situations, authorization is based on the combination of something the customer possesses and something the customer knows.

Remote Payment Account Creation

Customers can establish an electronic payment account within the customer account (28) remotely using a variety of interface devices including wireless or wired Internet devices or wireless or wired telephones. This can occur upon initially establishing a customer account, or it can occur some time after the customer account has been established. This electronic payment account can be used to pay for goods and services directly or to fund a stored value account.

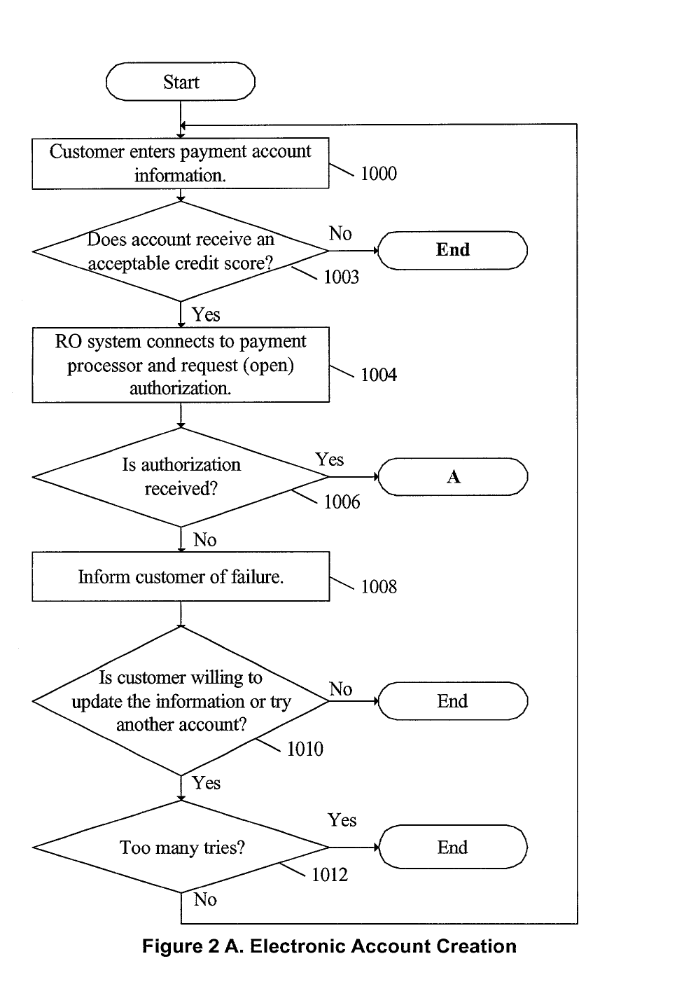

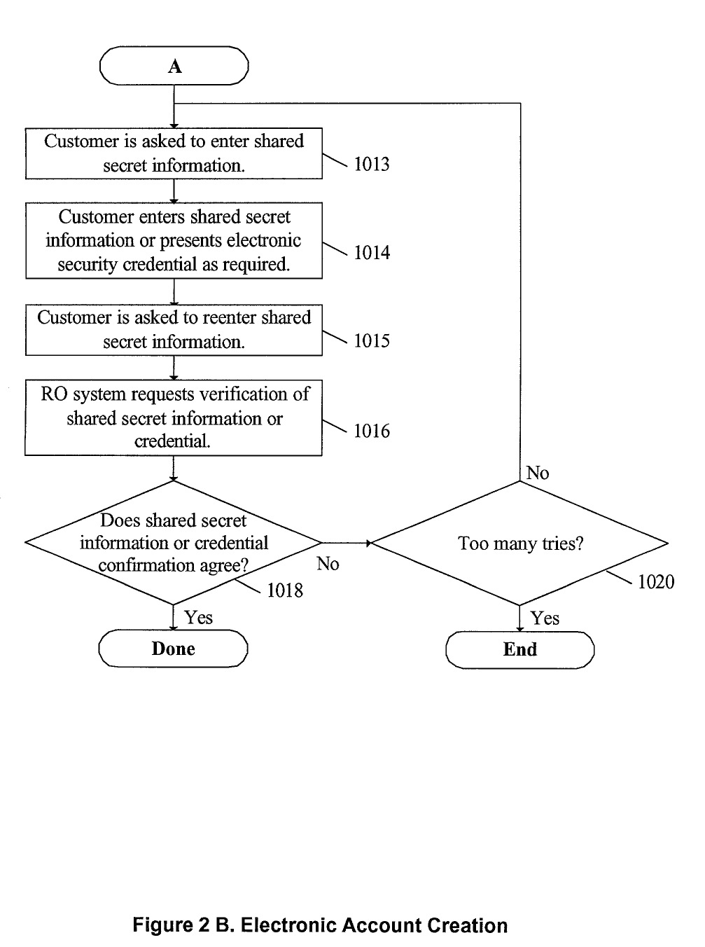

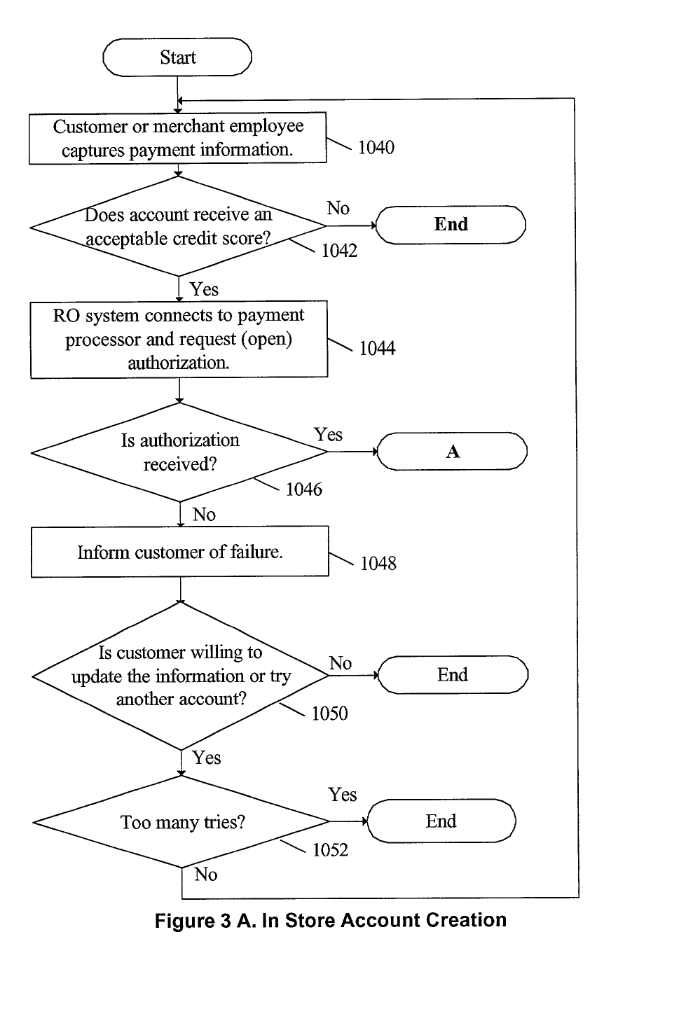

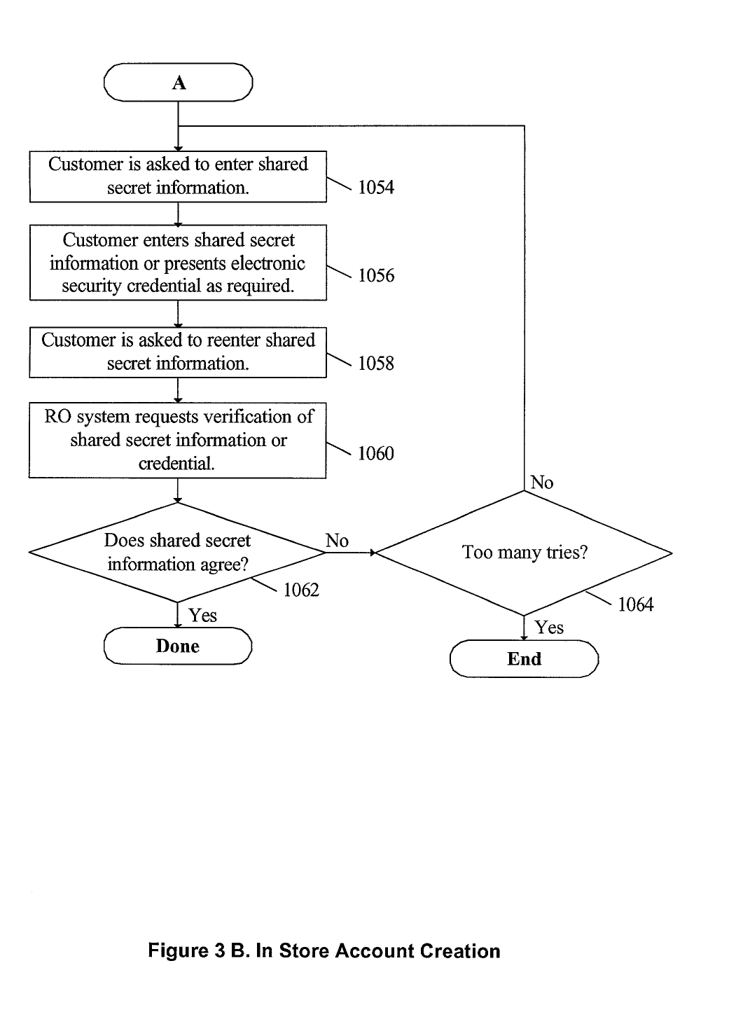

The payment account information is stored in the customer account (28). A flow chart of the basic process is shown in FIGS. 2A and 2B. FIGS. 2A and 2B contemplate the remote establishment of a payment account either upon initial establishment of the customer account or at some later time after the customer account has been established. The alternative process, wherein the payment account is created (and information captured) at the merchant's point of sale is described in the next section and is shown in FIGS. 3A and 3B.

Referring to FIGS. 2A and 2B, the customer initiates the account creation by connecting through the customer access gateway (42), entering payment account information (1000) into their interface device (52), which transmits the information to the RO system via the customer access gateway (42). Ideally a secure connection (i.e. SSL or similar technology) is used for this transmission. Suitable payment accounts include credit accounts and debit accounts (including Electronic Funds Transfer or EFT, and Automatic Clearing House or ACH).

In one embodiment of the invention, (shown in FIGS. 3A and 3B) the customer's payment account information is captured at the POS on the merchant's terminal (50) from a magnetic of smart card or check draft when the customer attends at the merchant's location to activate the account and pickup their order. This alternative alleviates the customer of the burden of correctly entering payment account information. According to this embodiment, the customer account may be provisionally created when the new customer remotely places the initial order. The provision of a customer identifier is contemplated so that the order may be matched to the individual upon the individual's attendance at the point of sale. The provisional creation of a customer account allows the remote ordering system to process the order and to deliver the order to the merchant point of sale. Upon the customer's attendance at the merchant's point of sale to receive order fulfillment, the relevant payment account information is electronically captured by the merchant's terminal (for example while processing payment from the customer's credit card).

Once the customer has supplied payment account information, the RO system then screens the account information for fraud (1002). The security manager (18) uses either internal (34) or external databases and processing capability to apply credit scoring, negative account matching, fraud profiling and other fraud screening methods to rate the account as worthy or not. If the account information does not meet the merchant's or processor's minimum criteria the payment account establishment process will generally be terminated.

Once the account has been scored for fraud (1002), the RO system connects (1004) to the appropriate payment processor (56) through the payment switch (14) and requests an authorization. Depending on the payment type this authorization process may be real-time or batch. When real-time processing is employed the RO system waits for the authorization to proceed with the account setup. When batch processing is employed the RO system will continue processing the account setup but may not activate the account until an authorization is received. With a batch process the authorization may, for example, be processed using an ACH test batch.

In an alternative embodiment the credit scoring and fraud screening is performed by the acquiring payment processor (56). In this case the security manager (18) will authorize the activation of the account (or not) based on the results of this fraud check.

If the payment processor (56) does not return an authorization (1006) to the payment switch (14) the customer access gateway (42) will connect to the customers interface device (52) and inform them of the authorization failure (1008). If the customer wishes to try another payment account (1010) and if the limit of attempts (1012) has not been reached the payment account creation process will be retried. The number of tries allowed is determined by the rules of the processor and the merchant.

Once the electronic payment account has been established, the security manager (18) requests that the customer inputs (1013) some type of shared secret information through the customer access gateway (42) (in the case of remote account creation) and the customer enters this information (1014) into the their access device (52) which transmits it to the RO system through the customer access gateway. The customer is then asked (1015) to reenter this information as a verification. The customer reenters the information (1016) into their interface device, which transmits it to the RO system through the customer access gateway. The security manager (18) verifies the agreement of the shared secret information (1018). If there is not agreement the security manager will request through the customer access gateway that the customer input the shared secret information again if there have not been too many tries (1020). The number of tries allowed is determined by the rules of the processor and the merchant.

In the case of in-store account creation, it will be appreciated that the shared secret information can be effectively exchanged in person when the customer attends to the merchant's location using the merchant's IT equipment (50).

In an alternative to direct exchange of shared secret information, the customer's electronic credential may be embedded in a wireless access device (52), which connects to the RO system through the customer access gateway (42) using either a wide area wireless network or a local area wireless base-station located at the store. The process used for establishing the payment account follows a nearly identical flow to the one already described in this section, but with the electronic credential being used as an alternative to the shared secret information. The electronic credential typically will itself require use of some shared secret information. In this embodiment, the customer is usually authenticated by an external authority, which can include a PKI Certificate Authority (CA) or an authentication authority using secret key cryptography. This authority is operated by a number of entities including, an Internet service provider, a telecommunications provider, a financial institution or payment processor or a third party certification authority. The payment account being used can be held and processed by the same certification authority. In this alternative embodiment, the security manager (18) (through security protocol adaptors) and the payment engine (12) (through the payment switch) interface to the certification authority or external processor (56), through the payment switch (14).

Alternatively, the security manager (18) asks customers using electronic security credentials for shared secret information. The customer enters this information into their access device (52) and it is transmitted to the security manager through the customer access gateway (42). This shared secret information is used later for account activation in cases where the authentication of the customer or the certification authority is not verifiable or where the service provider for the security credential is not a certification authority (that is, they issue secure credentials, but cannot certify the authenticity of the customer). Most Certificate Authorities in operation today fall into this category. That is, they only issue and authenticate certificates, but are not certification authorities who can validate the customer's identity. Alternately, this shared secret information can be used to activate the customer's account at the point of sale without the need for the customer or the RO system to reconnect to the certification authority.

Once the shared secret information and/or security credentials have been validated, the payment account is activated.

In Store Payment Account Creation

In one embodiment of the invention, customers establish an electronic payment account within the customer account (28) while attending at the merchant's store location after having placed at least an initial order through the RO system. This process can be performed at any time the customer wishes to add electronic payment options to their customer account (28). This in-store activity can be done using a variety of interface devices including dedicated payment terminals (50) and integrated POS systems (50) or a self-service kiosk (50) at the merchant's store location. While establishing an electronic payment account at a store location is typically done while the customer is placing or picking up an order, including an initial order, it can be done at any time. The electronic payment account can be used to pay for goods and services directly or to fund a stored value account. A flow chart of the basic process is shown in FIGS. 3A and 3B.

The customer or merchant employee initiates the payment account creation by capturing payment account information (1040) into the payment terminal, integrated POS system or self-service kiosk (all merchant IT equipment 50). In the preferred embodiment, the customer or merchant employee will electronically capture the payment account information. This capture can involve swiping a magnetic card, reading information from a smart card, capturing account information from a check draft, etc. Alternatively, this information can be captured by manually entry. Suitable payment accounts include credit accounts and debit accounts (including Electronic Funds Transfer or EFT and Automatic Clearing House or ACH). In either case, the information is transmitted from the merchant's IT equipment (50) to the RO system via the order delivery system (44).

The RO system then screens the account information for fraud (1042). The security manager (18) uses either internal (34) or external databases and processing capability to apply credit scoring, negative account matching, fraud profiling and other fraud screening methods to rate the account as worthy or not. If the account information does not meet the merchant's or processor's minimum criteria the account creation process will generally be terminated. Those skilled in the art will be familiar with established and emerging payment industry practice for fraud screening.

Once the account has been scored for fraud (1042), the RO system connects (1044) to the appropriate payment processor (56) through the payment switch (14) and requests an authorization. Depending on the payment type this authorization process may be real-time or batch. When real-time processing is employed the RO system waits for the authorization to proceed with the account setup. When batch processing is employed the RO system will continue processing the account setup but may not activate the account until an authorization is received. With a batch process the authorization may, for example, be processed using an ACH test batch.

In an alternative embodiment the credit scoring and fraud screening is performed by the acquiring payment processor (56). In this case the security manager (18) will authorize the activation of the account (or not) based on the results of this fraud check.

If the payment processor (56) does not return an authorization (1046) to the payment switch (14) the customer access gateway (42) will connect to the customer's access device (52) and inform them of the authorization failure (1048). If the customer wishes to try another payment account (1050) and if the limit of attempts (1052) has not been reached the payment account creation process will be retried. The number of tries allowed is determined by the rules of the processor and the merchant.

Once the electronic payment account has been established within the customer account (28), the security manager (18) requests (1054) that the customer inputs some type of shared secret information (1056). The customer is then asked (1058) to reenter (1060) this information as a verification. The request and the shared secret information are transmitted between the RO system and the terminal (50) at the merchant's location though the order delivery system (44). The requests are displayed and the shared secret information entered using a dedicated payment terminal, an integrated POS or the self-service kiosk (collectively, the merchant IT equipment 50). The security manager verifies the agreement of the shared secret information (1062). If there is not agreement the security manager will request through the order delivery system (44) that the customer input the shared secret information again if there have not been too many tries (1064). The number of tries allowed is determined by the rules of the processor and the merchant.

In an alternative embodiment, the customer's electronic credential is embedded in a wireless access device (52), which connects to the RO system through the customer access gateway using either a wide area wireless network or a local area wireless base-station located at the store. The process used for establishing the payment account follows a nearly identical process flow to the one already described in this section, but with the electronic credential being used as an alternative to the shared secret information. The electronic credential typically will require use of some shared secret information. In this embodiment, the customer is usually authenticated by an external authority, which can include a PKI Certificate Authority (CA) or an authentication authority using secret key cryptography. This authority is operated by a number of entities including, an Internet Service Provider (ISP), a telecommunications provider, a Financial Institution (FI) or payment processor or a third party certification authority. The payment account being used can be held and processed by the same certification authority. In this alternative embodiment, the security manager (18) (through security protocol adaptors) and the payment engine (12) (through the payment switch 14) interface to the certification authority or external processor. Requests for information to merchant employees and responses displayed for merchant employees are communicated to the terminal (50) at the merchant location through the order delivery system.

In yet another alternative embodiment, the customer can authenticate himself or herself with the electronic credential remotely and entering shared secret information into the RO system interface at the same time (as is shown in FIGS. 2A and 2B). The customer then uses the shared secret information for account activation when attending the merchant's location to authenticate they are the same person using the certificate. This method has the advantage of not requiring the customer to take the device (which may not be portable) to the merchant's location.

Account Activation and Verification of Customer Identity

Once the customer has completed the ordering process the remote ordering system transmits the order to the IT equipment (50) at the merchant's location. If the customer wishes to activate an electronic payment account this is preferably done before the customer's order is fulfilled. At the same time the order is printed or displayed, a contract or payment service agreement is printed on the merchant terminal or POS system (50). Typically one copy of the contract will be printed for the customer's records and one copy of the merchant's records. Merchant employees will have the customer sign the contract and verify the customer's identity as required. Once the customer has been authenticated (for example by verifying the customer's identity using photo identification) and a signature captured on the service contract, the merchant and the customer have a secure basis for subsequent transactions with agreed to terms and conditions. In general the shared secret information, possibly combined with a security credential, is then used for future payment transactions.

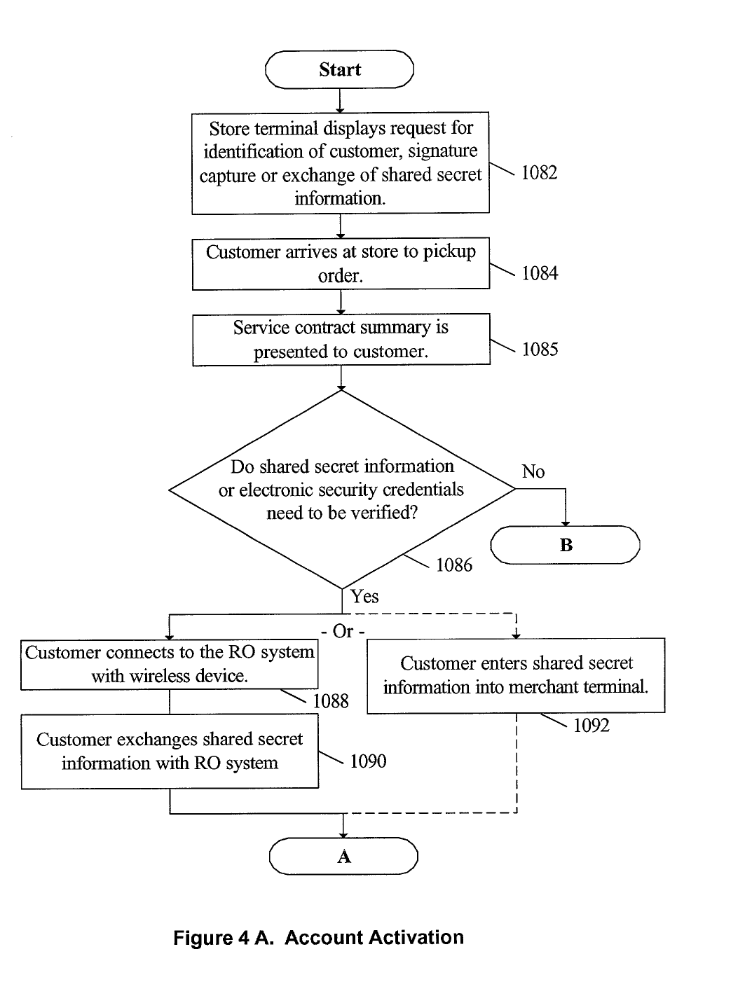

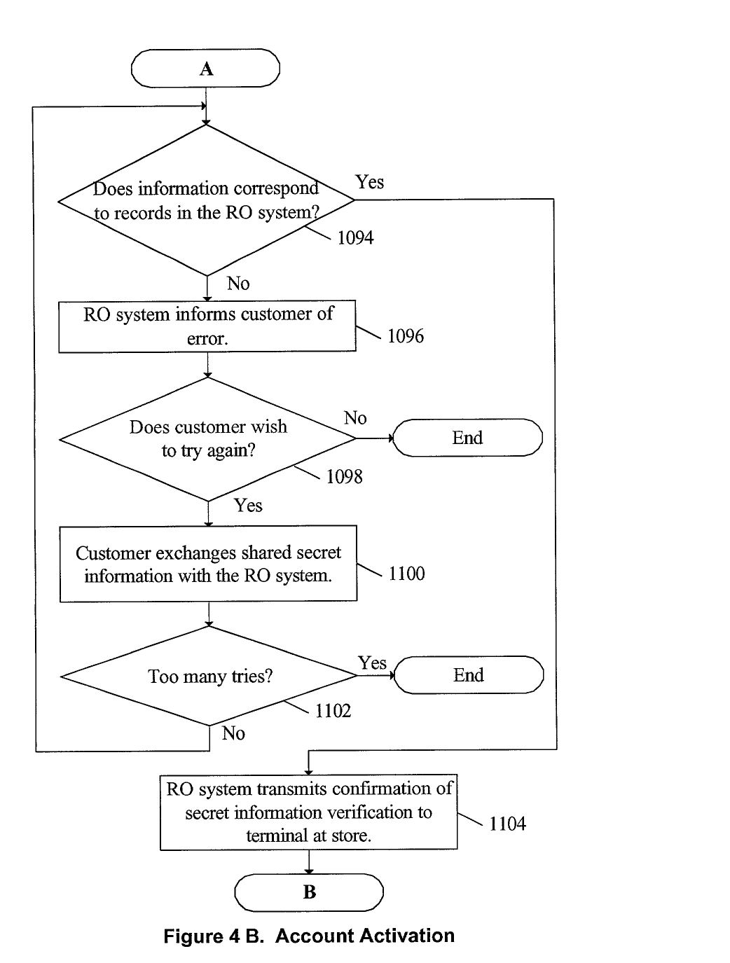

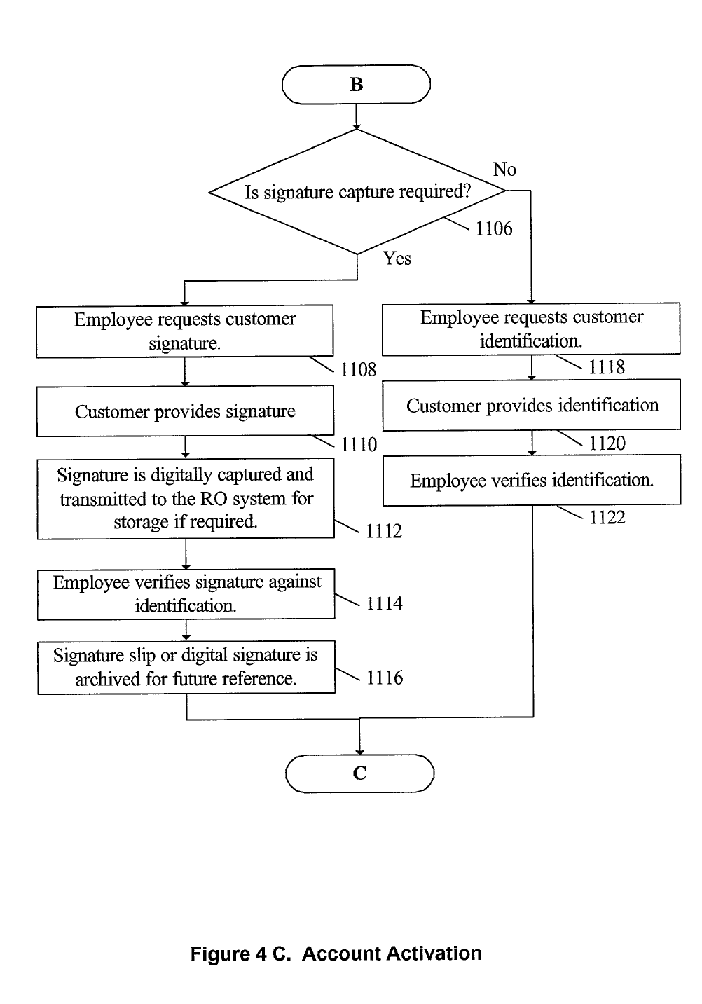

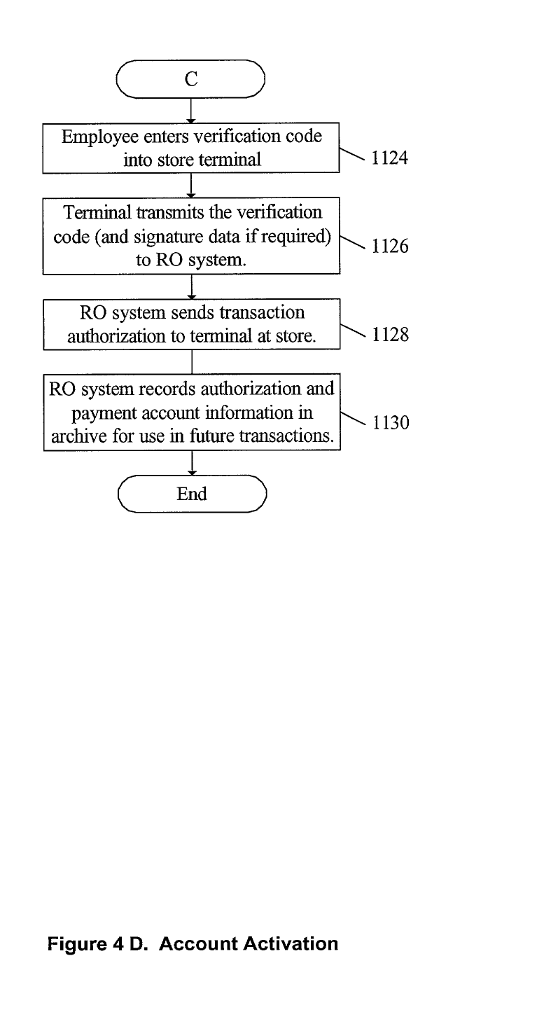

The basic flow for the payment account activation process is shown in FIGS. 4A, 4B, 4C and 4D. This process flow is mediated by the security manager (18), which applies to a variety of authentication protocols using the appropriate authentication protocol adaptors. Usually, this process is performed when the customer arrives at the merchant's store location to pick up their initial remote order or an electronic order placed from the store. In this case the order is prepared based on an open payment authorization, which is closed when the customer is authenticated and the account activated.

The order and contract are transmitted through the order delivery system (44) over a wired or wireless data network to a terminal or POS system (50) at the merchant's location. The order data can be displayed on the terminal or presented in printed form (printed by the terminal or POS system) or both. The order data will include information to identify the customer, typically in the form of a telephone number or device ID. Alternatively a user name or alias can be used, but is not required for the invention. Other identifying information such as a vehicle description or license number can also be displayed. Once the order is received the merchant's employees can begin preparing it. The paper contract will typically include the customer's legal name and will have a signature line. The customer can identify himself or herself to the merchant's employees by their telephone number, device ID, user name, legal name or alias.

The printed or displayed information includes the request to verify the customer's identification, verify shared secret information or security credentials, or to capture a customer signature (1082) as required for the payment type being used. When the customer arrives at the store (1084), the customer is presented with a summary service agreement contract (1085), and the need is determined (1086) to verify the customer's security credential or shared secret information. The verification process can include checking of a photo ID, verification of ID number information (i.e. account or other numbers entered during account creation), and matching of signatures.

If the customer is using a mobile wireless access device (52) as a security credential they connect (1088) to the RO system through the customer access gateway (42) and can then verify the shared secret information or security credential (1090) in the presence of the merchant employee. Alternatively, the customer can enter (1092) the shared secret information into the merchant's terminal (50) in the presence of the merchant employee. In this case, the shared secret information is transmitted from the terminal to the RO system through the order delivery system (44). In either case, the shared secret information or security credential is verified (1094) and a confirmation is transmitted through the order delivery system to the merchant terminal where a confirmation is displayed (1104) for the merchant employee. Optionally, the merchant employee can transmit a confirmation of the authentication process to the customer's wireless device, which gives the customer assurance that the merchant connection was authentic, if a wireless device is used as an authentication credential.

If the confirmation of the shared secret information or security credential fails (1094) the customer will be informed of the failure (1096) either through the merchant terminal (50) or their wireless access device (52). If the customer wishes to try again (1098) the customer reenters the shared secret information or electronic security credential (1100). If there have not been too many attempts by the customer (1102), the RO system will verify (or not) the shared secret information or security credential (1094). The number of attempts allowed is determined by the merchant and processor's business rules.

If signature capture is required (1106) the employee will ask (1108) the customer for a signature and the customer provides the signature (1110). The signature can be captured on a paper form produced by a printer attached to the merchant terminal or POS (50). Alternatively, if the merchant IT equipment (50) is equipped with the proper peripherals, the customer's signature can be captured by electronic means, either directly (using an electronic tablet and stylist for example) or by scanning the paper contract. The digitally captured signature is then transmitted through the order delivery system (44) to the RO system (1112) where it is achieved in the data warehouse (38). The merchant employee will then verify the customer's signature and identification (1114). Either the paper form or the digital signature are archived (1116) in a manner allowing retrieval in the event of a dispute with the customer (repudiation of a payment transaction) or suspected fraud. The printed contract document can be a full set of the terms and conditions or can be a summary. If a summary form of the contract is used, the customer can receive a full copy on line (on World Wide Web or email), through the mail in printed form, or distributed in printed form by the merchant employee.

If signature capture is not required the employee will request identification from the customer (1118). The customer provides identification (1120) and the merchant employee then verifies the identification (1122).

Once the customer's identity has been verified and a signature captured, as required, the employee enters (1124) a verification code into the terminal or POS system (50). The terminal or POS system transmits the verification code though the order delivery system (44) to the RO system (1126) where it is archived in the customer account (28) and the merchant account (30). At the same time digital signature information is transmitted if required. Once all information is logged in the RO system, the RO system sends a final authorization (1128) for the open authorization through the order delivery system to the merchant terminal for display to the merchant employee. The RO system then records all information required (including security information) required for future payment transactions (1130).

Capture of Payment Account Information at POS

In the preferred embodiment, the customer's payment account information can be captured at the point of sale during the account activation process. This process allows customers to create payment accounts without the need to actually enter the payment account information (account holder name, account number, routing numbers, etc.). This process saves customers time and also prevents errors arising from manual data entry. In addition, the level of fraud will be reduced, since the customer is required to present a physical payment instrument and the merchant can verify customer identity and signature. The process flow for this account activation process is the same as that presented in the discussion above and shown in FIGS. 4A, 4B, 4C, and 4D.

The requirement to capture payment information is indicated on the printed or displayed information shown (1082) on the merchant's terminal or POS system (50). When the customer arrives at the point of sale (1084), the merchant employee requests the customer's payment instrument and captures the payment account information electronically using the appropriate peripherals attached to the merchant IT equipment (50). The IT equipment transmits the payment account information through the order delivery system (44) to the payment engine (12) which requests an authorization (if real-time authorization is available) from the payment processor (56). If the authorization is received it is sent to the merchant IT equipment where it is displayed. The merchant employee then presents the printed service contract (1085) to the customer. Forms of suitable payment instruments include at least the following:

1. a credit card where customer identity (account holder name), account and security information is collected by ether reading a magnetic stripe of a smart card,

2. a debit card (on-line or off-line) from which the customer identity, account information and security information (including perhaps a competed PIN offset) are collected by reading either a magnetic stripe or a smart card, and

3. a check draft, which is scanned to extract identity and account information.

In some cases (particularly scanned checks) not all information will be acquired electronically. In this case a keypad attached to the merchant IT equipment (50) is used for the merchant employee or customer to enter the missing information.

In addition, the keypad is used to enter identity (telephone number, device ID, etc.), payment account information or security information (i.e. a PIN).

Once the payment account information has been captured and stored in the customer account (28), this information, usually combined with exchange of shared secret information, can be used for subsequent transactions without the need for the merchant or customer to handle the physical payment instrument again.

Issuing a Card

In an alternative embodiment, the merchant can issue the customer a card at the end of the account activation process. The card can be used for identification and to facilitate payment processing during subsequent transactions. The card can be combined with the use of shared secret information (e.g. a PIN) for added security in the future. The card can use magnetic strip, smart card or bar coded technology. Alternatively, a Radio Frequency Identification (RFID) device or other type of electronic token can be issued.

Once the customer account has been activated, using the processes discussed above, the merchant employee will activate the card using appropriate peripherals on the merchant IT equipment (50). The merchant IT equipment captures the card number, security information and any other identifiers and transmits them through the order delivery system (44) to the transaction manager (10), which passes the information to the security manager (18). The security manager verifies the information in the merchant account (30) and the security information store (34) and sends a confirmation of the activation back to the merchant terminal through the transaction manager (10) and order delivery system (44). If an error occurs in reading or activating the card, the merchant employee is instructed to try another card. Once the card is activated it is presented to the customer, who may be asked to sign it.

In subsequent transactions the card can be used to access a stored value account, loyalty points or other bonuses and promotions, or, possibly combined with shared secret information, as a surrogate for other payment credentials (i.e. a check draft). The card can also be used to identify the customer to the merchant employee and query records of the customer's previous purchases. In subsequent transactions, the customer presents the card to a merchant employee, who reads it using appropriate peripherals of the merchant IT equipment (50). If required, the customer enters shared secret information. The card information is transmitted through the order delivery system (44) to the security manager (18), which verifies the information in the customer account (28) and the security information store (34). The transaction manager then queries the customer account for payment, purchase and loyalty information, and transmits this information back to the merchant IT equipment for display and use.

Limits on New Accounts

Depending on merchant, payment processor and RO system operator business rules and the type of payment account being used by the customer, limits may be placed on a newly activated account. With some types of electronic payment instruments (e.g. credit accounts and PIN based debit accounts) an on-line authorization for payment is received in real-time or near real-time. In this case there is generally no need for limits on the account. With payment instruments that do not provide on-line authorizations (e.g. off-line debit or ACH) limits will be justified to limit the merchant's initial risk until an initial settlement is successful. Even if an on-line authorization is available limits may be justified to limit the risks from situations such as charge-backs, stop payment orders and accounts with Non-Sufficient Funds (NSF) that can affect ultimate settlement. The payment engine (12) enforces these limits using information queried from the customer account (28) and the merchant account (30). Examples of these limits include activating the account to allow fulfillment of the initial order but not allowing any addition orders to be processed until initial settlement succeeds, or allowing subsequent orders to be fulfilled up to a present value limit until initial settlement has succeeded.

Even once initial settlement has succeeded limits may still be desirable until the customer has established a record of reliable settlement from their payment accounts (i.e. no charge-backs, stop payment orders or NSF). Limits will generally be increased in stages as the customer develops a history of reliability.

Limits on Established Accounts

Depending on system operator, payment processor and merchant rules, and the type of payment account being used, payment limits may be placed on or lowered for established customer accounts. Examples of cases where limits would be applied to a customer's account include a sudden change in the frequency or value of purchases, or a failure of settlement, including charge-backs, stop payment orders and accounts returned NSF.

The payment engine (12) enforces these limits using information queried from the customer account (28), the merchant account (30) and received from the payment processor (56) through the payment switch (14). Examples of these limits include placing a hold on all subsequent orders, or limiting the value or frequency of subsequent orders.

Payment Account Expiration

Certain electronic payment account types (e.g. credit accounts) have expiration dates. In other cases, the customer may close a payment account and forget to update their payment account information in the customer account (28). In this case, the payment engine (12) will typically be informed of the closed account situation by the payment processor (56) when a settlement fails.

When the customer attempts to use an expired payment account or a closed payment account they are notified by the payment engine (12) through the customer access gateway (42) of the problem. The system processes the order in the usual manner, but when the transaction manager (10) transmits the order to the merchant IT equipment (50), through the order delivery system (44), information is attached alerting the merchant employees that the customer's payment account has expired. This information will be displayed in electronic or printed from on the merchant's terminal (50).

When the customer arrives at the store to pickup their order the merchant employee will ask them for new payment account information. This information is captured and the customer's identity verified using the processes already described in this document (see FIGS. 3A, 3B, 4A, 4B, 4C, and 4D). Once a new payment account is available, the merchant employee will complete fulfillment of the customer's order.

Payment Transactions

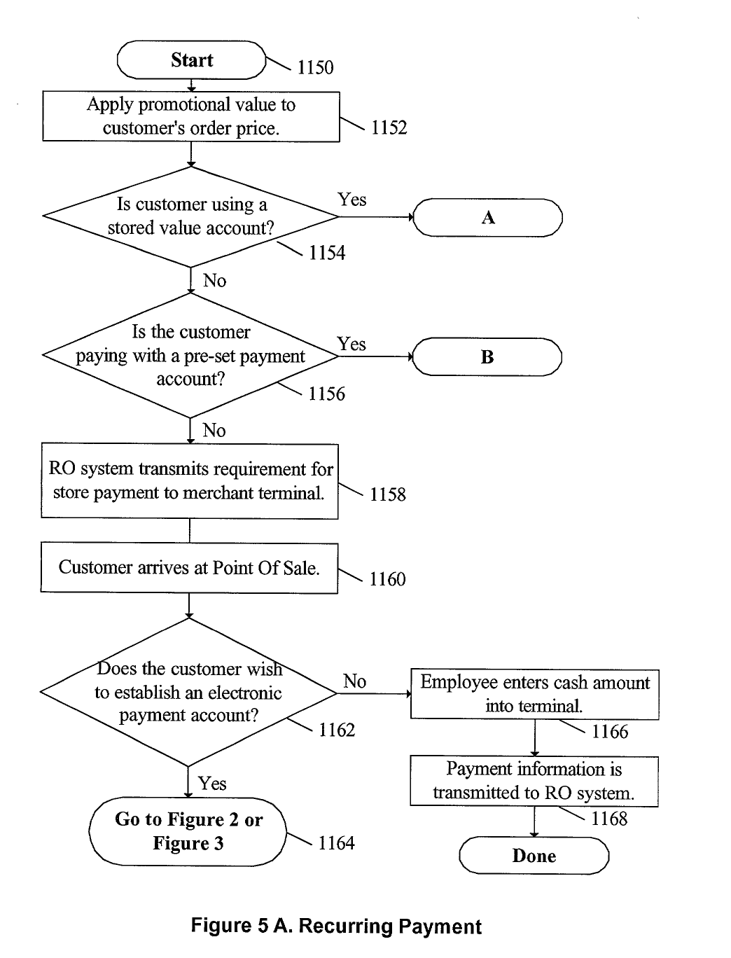

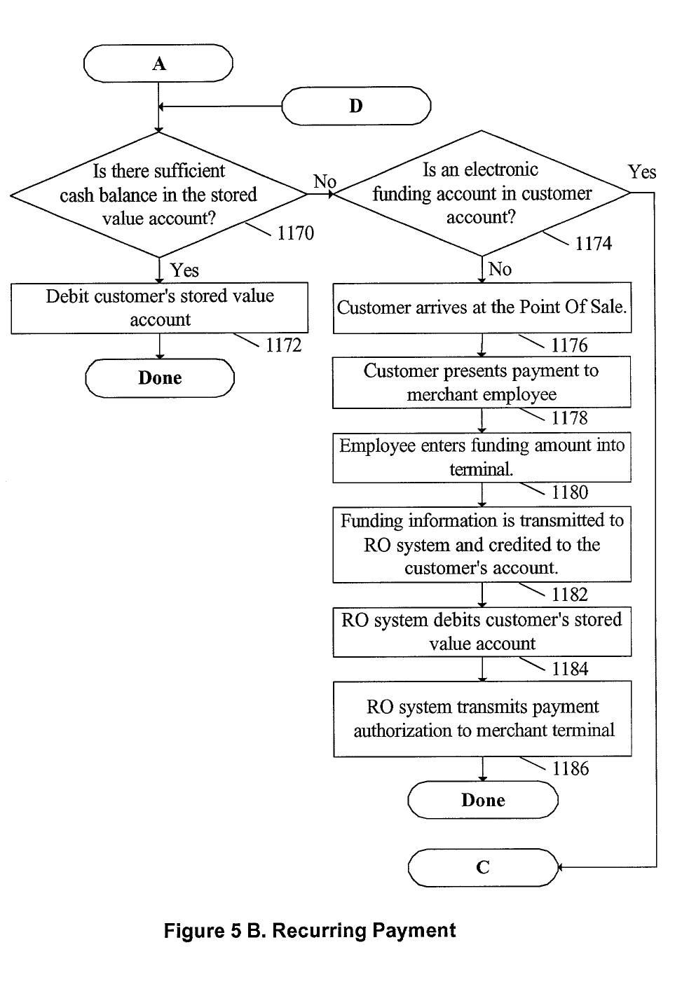

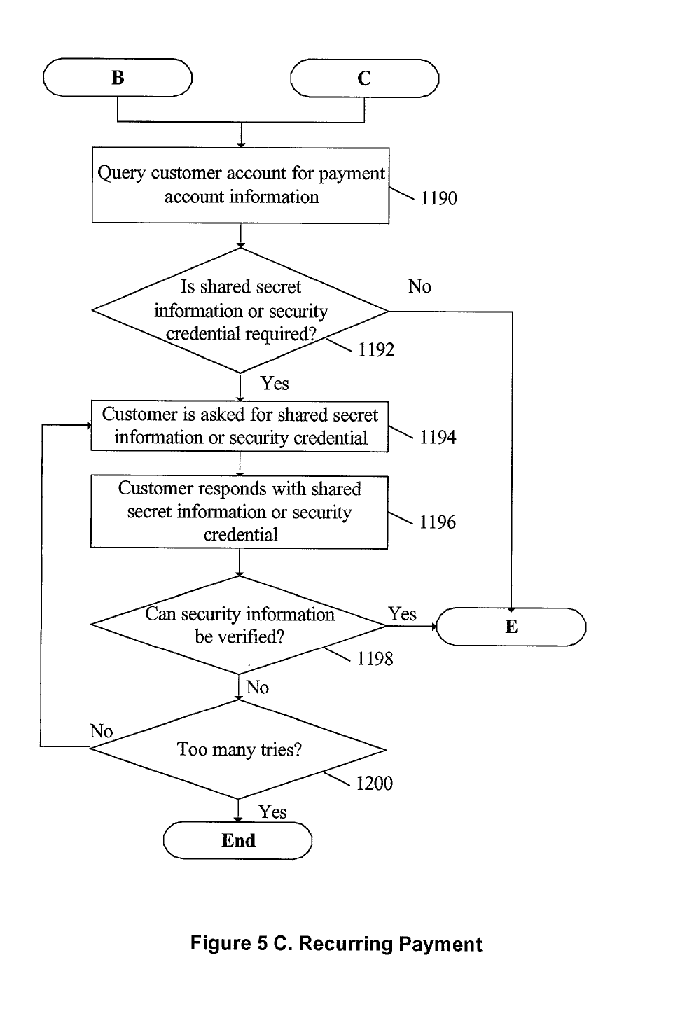

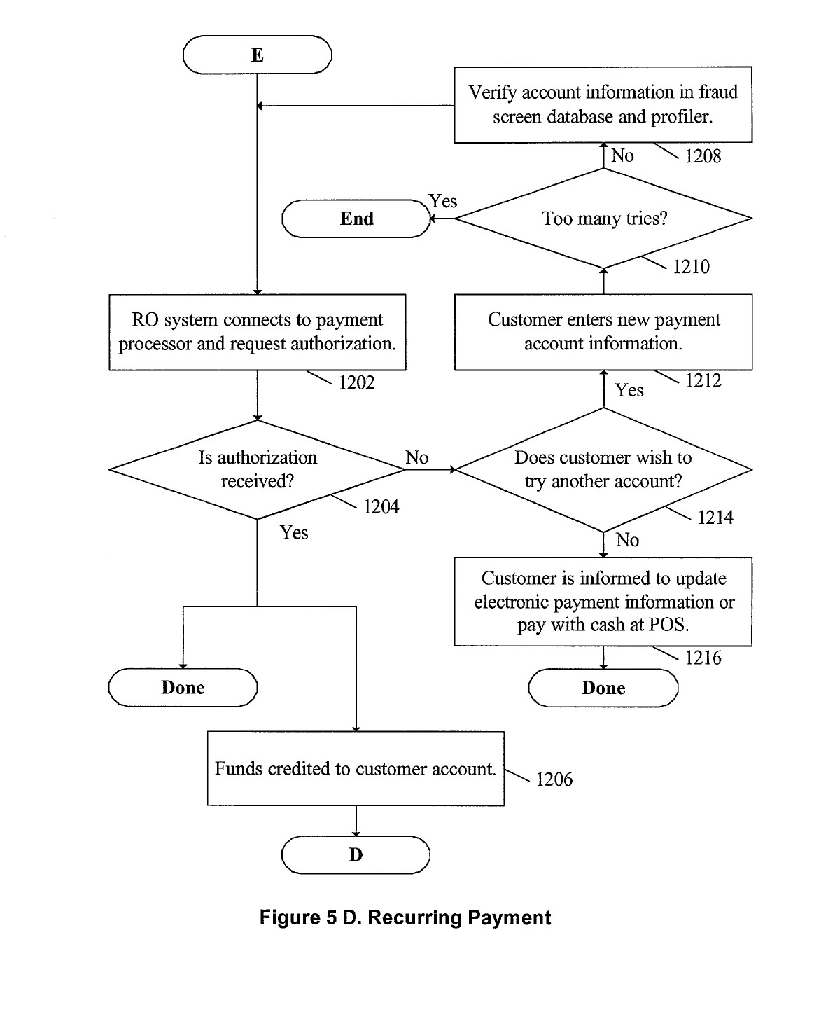

Once a customer's payment account has been established, the customer can use that account for subsequent payment transactions. These transactions can be secured using the previously verified, captured and stored shared secret information or security credential. These transactions are executed under the terms and conditions agreed to and signed for by the customer during the account creation and activation process. The payment process flow is shown in FIGS. 5A, 5B, 5C, and 5D.

The customer initiates the payment process (1150) either in person at the merchant's store location or electronically. The RO system will apply any promotional value (1152) to the value or the customer's payment. If the customer chooses to use a direct payment (1154), but does not wish to use a stored value or direct payment account (1156) for an electronic payment the RO system transmits the customer order and a request to process the payment (1158) at the merchant's store location once the customer arrives at the Point Of Sale (1160). During this process at the point of sale, the customer is then given the option (1162) of establishing an electronic payment account either electronically (see FIGS. 2A and 2B) or at the POS (see FIGS. 3A and 3B) (1164) as has already been described in this document.

If the customer is paying with a stored value account the stored value processor (16) determines if there is sufficient balance (1170) in the account. Depending on merchant rules, the customer may be allowed to spend their balance to zero, below zero (effectively an over draft) or may need to maintain a minimum balance. If the balance is sufficient, the stored value processor debits the customer's account (1172), returns a payment authorization to the transaction manager (10), which makes the proper account entries in the ledger systems (34) and logs in the data warehouse (38).

If the stored value account does not have sufficient balance and if the customer does not wish to fund the account electronically (1174) the customer proceeds to the point of sale (1176) to add funds to the stored value account. The customer presents the payment (1178) for the account funding to the merchant employee. The merchant employee processes the payment in the usual manner and enters the payment (funding) amount (1180) into the terminal or POS system (50). The payment can be in the form of cash, a check, credit or debit. This payment information is transmitted through the order delivery system (44) to stored value processors (16) where entries are made into the customer account (28) and the ledgers (32) or data warehouse (38).

The terminal or POS (50) software is designed to allow the merchant employee to automatically process these payments electronically, within the application or program (memory) space of the remote order application without the need to leave the RO application, process the payment in another application and switch back to the RO application. This reduces the burden on the merchant employee and speeds the process since no additional information needs be entered while switching between applications. This processing can include electronic check draft capture, capturing credit card information or debit card information from magnetic strip or smart cards and PIN entry and capture as required for the payment account. Electronic payment processing can be done using the faculties of the RO system in which case, the authorization request is transmitted from the terminal (50) to the RO system via the order delivery system (44) and forwarded to the payment processor (56) using the payment switch (14). Settlement for these funds is managed by the settlement manager (58) using information in the ledgers (32) and merchant account (30). Alternatively, the terminal or POS system (50) can use a separate connection (including “split dial” connection) directly to the payment processor (56). In this case, settlement is managed in the same manner as all point of sale electronic transactions.

Once the payment is processed (by whichever means), the employee enters the funding amount into the terminal (50), which transmits this information though the order delivery system (44) to the stored value processor (16), which credits (1182) the customer's account (30) and ledgers (32). The stored value processor (16) debits (1184) the customer's account (28) and makes entries in the ledgers (32) for the amount of the current transaction, and returns an authorization (1186) for display on the terminal (50) for the merchant employee.

An electronic payment can be used by the customer to either pay for an order directly or to fund a stored value account. When the payment engine (12) receives this request, it queries the customer's account (28) for electronic payment account information (1190). If shared secret information or other electronic security credential is required (1192) the customer is asked to enter this information or use a previously authenticated electronic credential (1194) under the direction of the security manager (18) and the customer complies with the request (1196). The request to the customer and the reply by the customer can be communicated through the customer access gateway (42) to the customer's access device (52) or through the order delivery system (44) to the merchant terminal (50). The security manager (18) verifies (1198) the shared secret information or security credential using information in the customer account (28) and the security information store (34). If the verification fails, and if the customer has not tried too many times (1200) the customer is allowed to repeat the process. The number of retries allowed depends on the merchant and processor's business rules.

The payment engine (12) connects to the payment processor (56) through the payment switch (14) and requests an authorization (1202). If the authorization succeeds (1204) the payment process is concluded with the payment engine making the appropriate ledger (32) and log entries in the data warehouse (38). If the stored value account is being funding the payment engine (12) instructs the stored value processor (16) to make the required ledger (32) and log entries in the data warehouse (38) to credit (1206) the customer account (28).

If the payment authorization fails the payment engine (12) asks the customer through either the customer access gateway (42) or the order delivery system (44) if they wish to try another payment account (1214). If the customer chooses not to try another account (1216) they are instructed to pay at the point of sale. If the customer does wish to try another payment account they enter (1212) the account information into either the merchant terminal (50) or their access device (52). If the customer has tried too many payment accounts (1210) the payment engine (12) (generally under direction of the security manager (18)) terminates the process. The payment engine screens the account information for fraud (1208) as has already been discussed in this document and the payment authorization is repeated. If successful, the payment account information is stored in the customer account (28) for subsequent use.

In Store Ordering

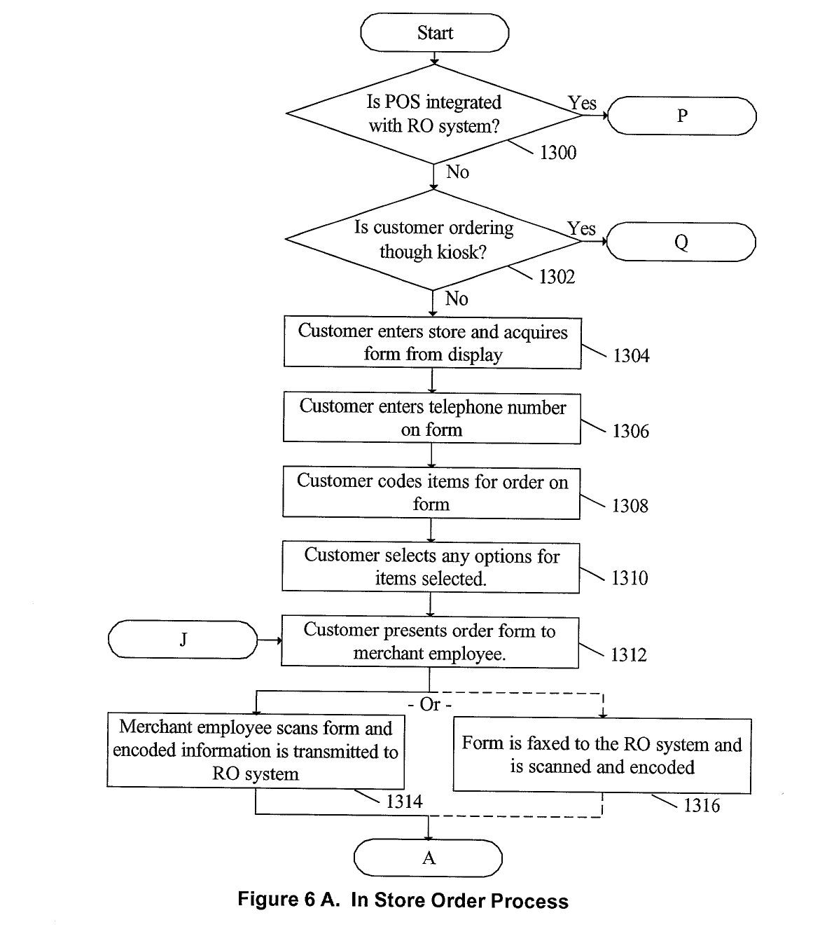

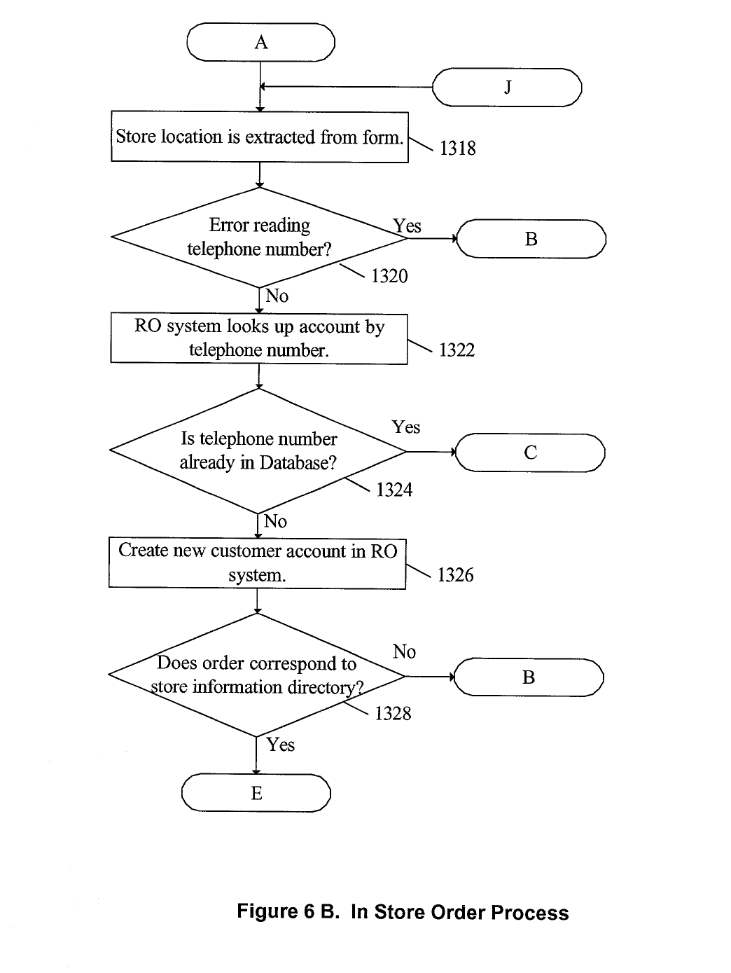

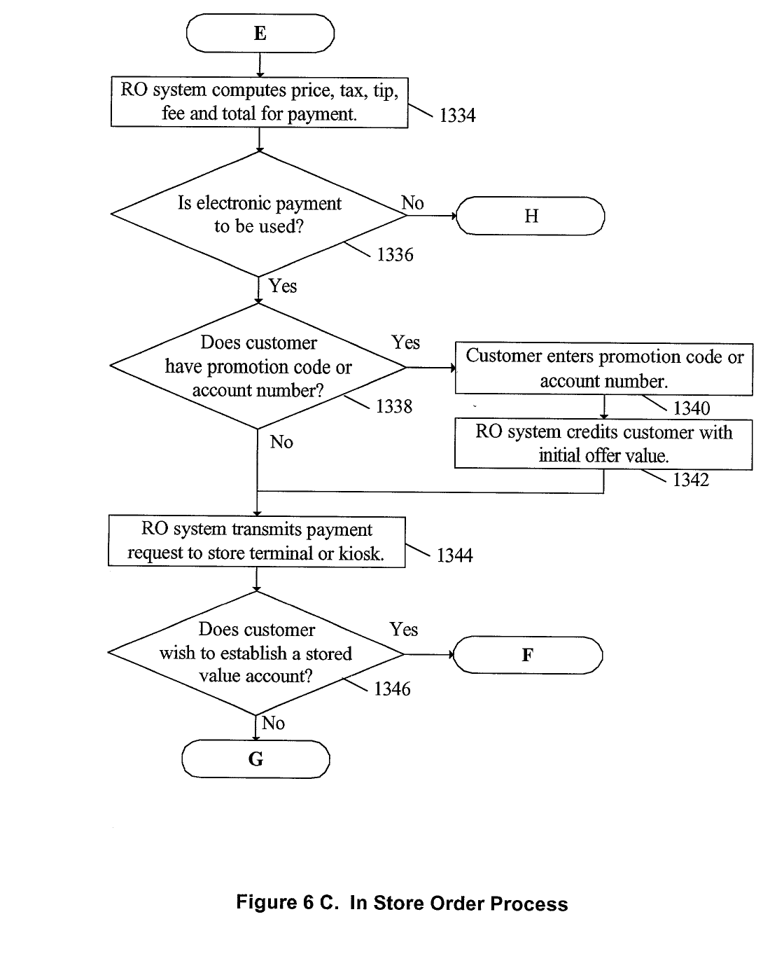

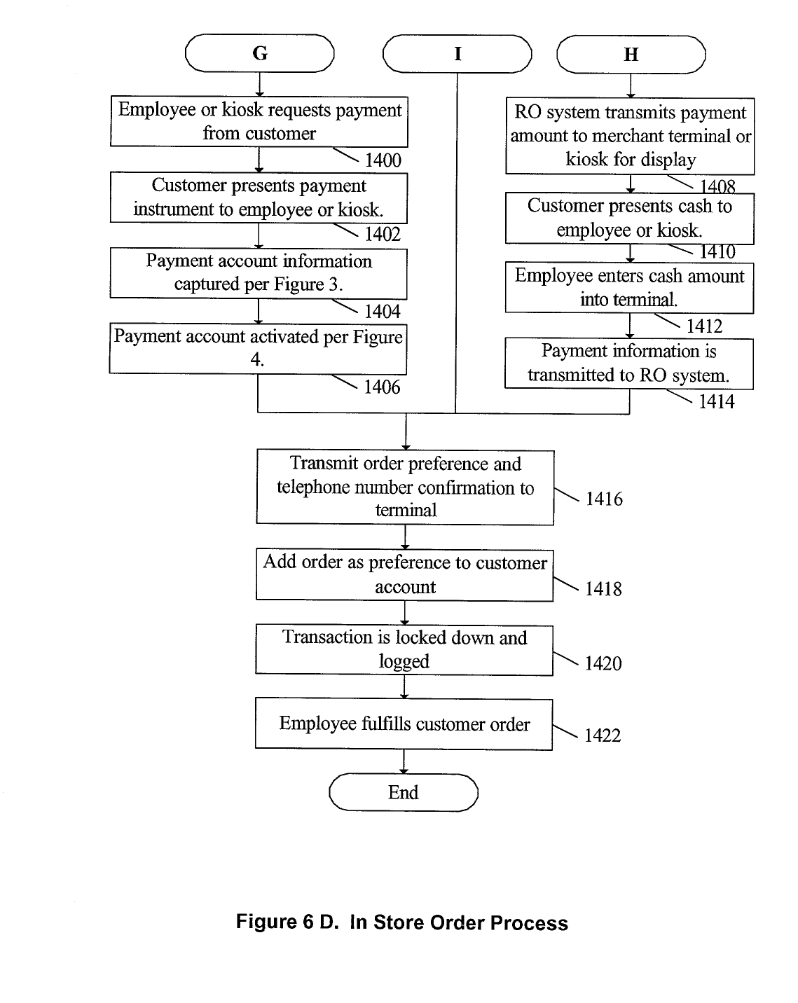

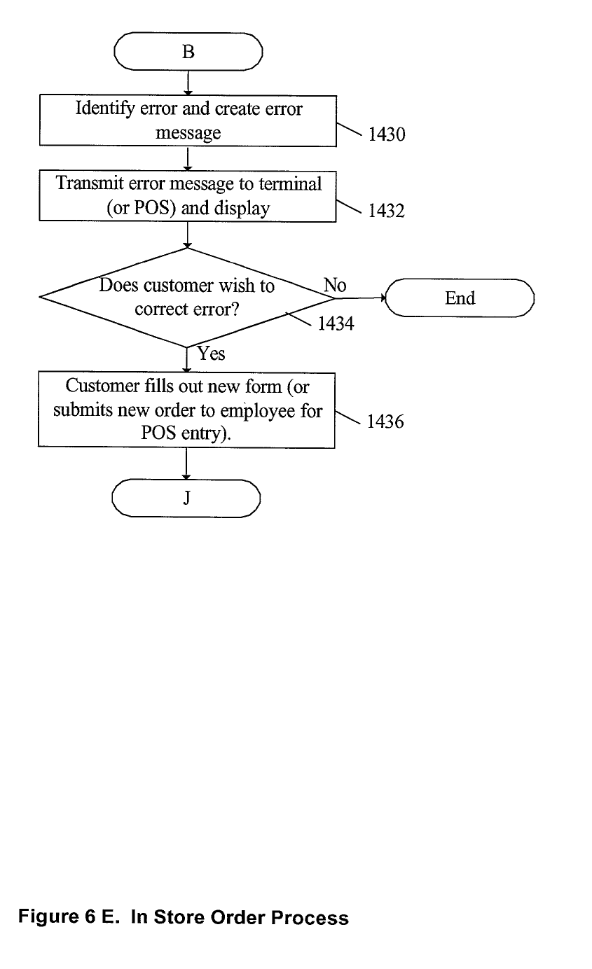

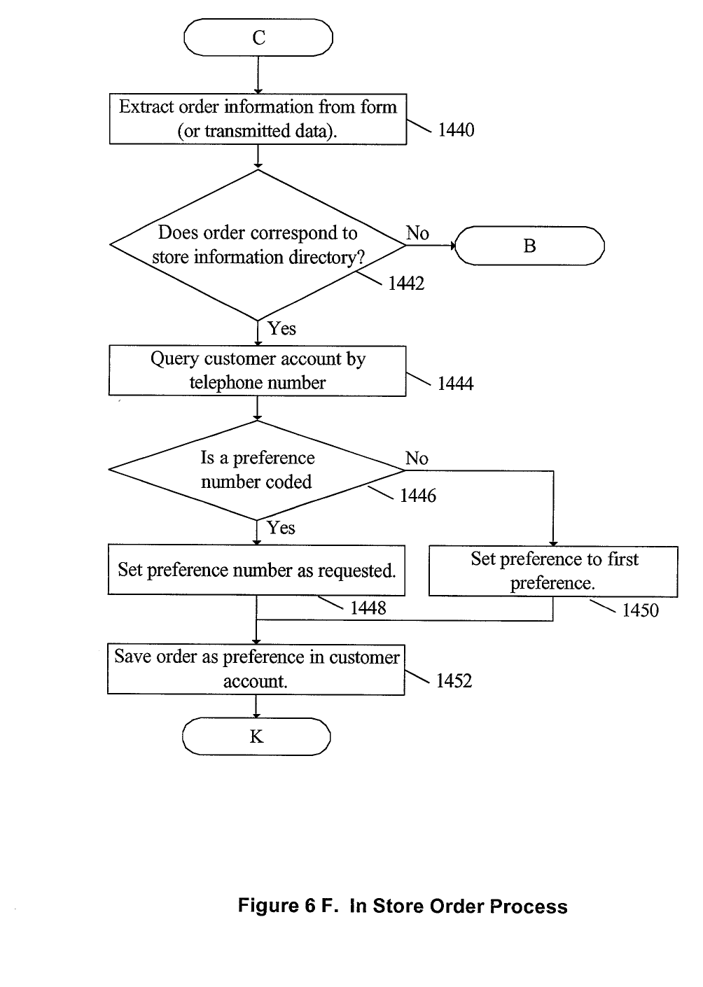

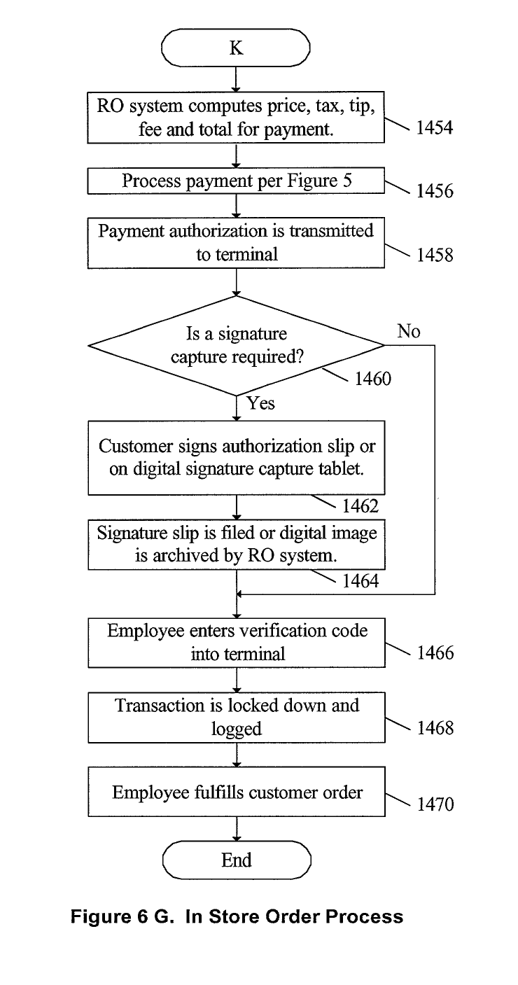

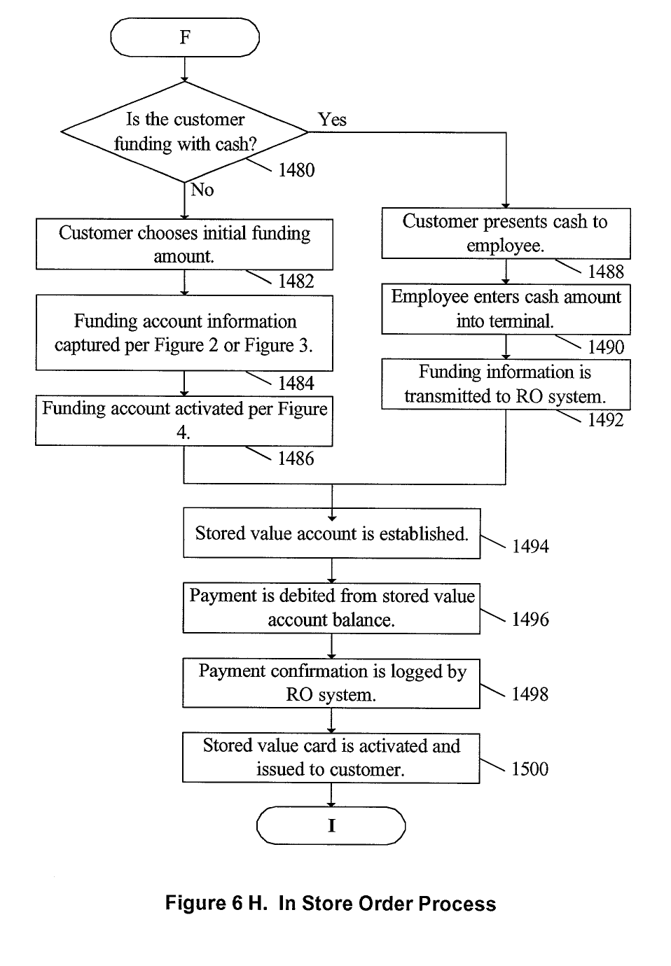

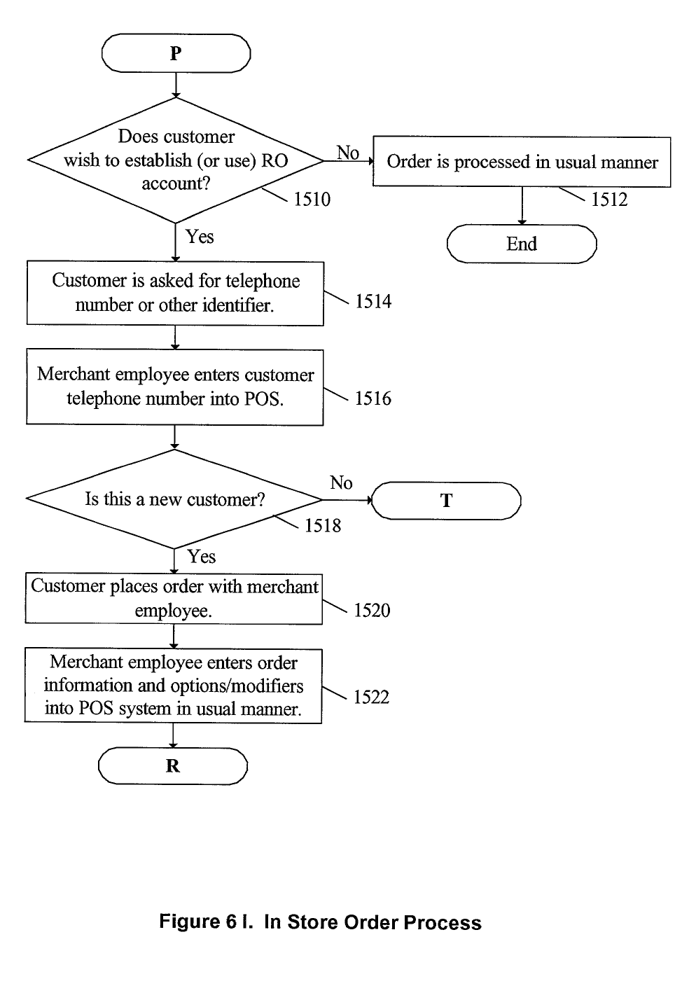

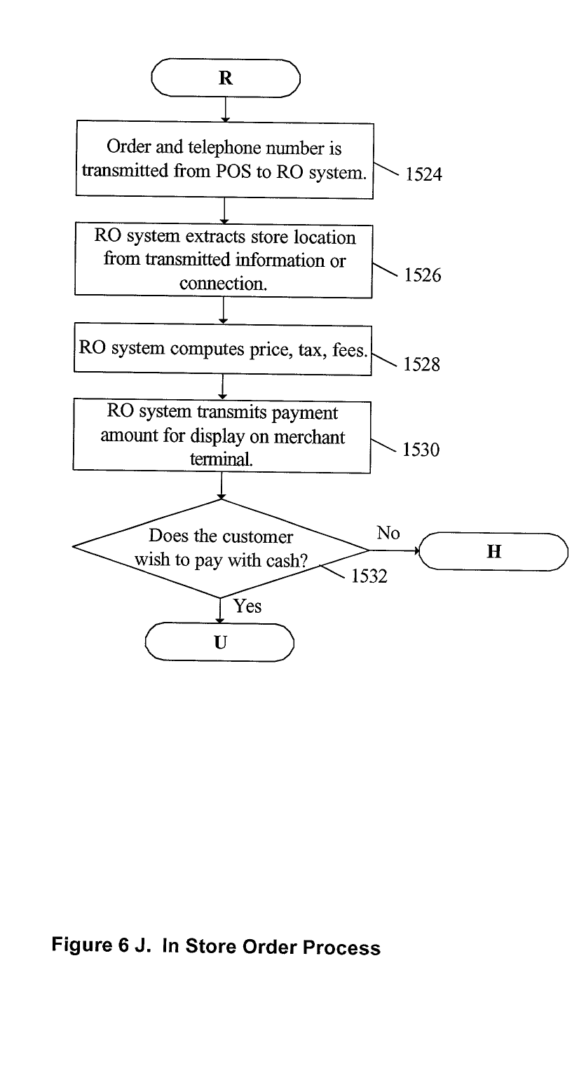

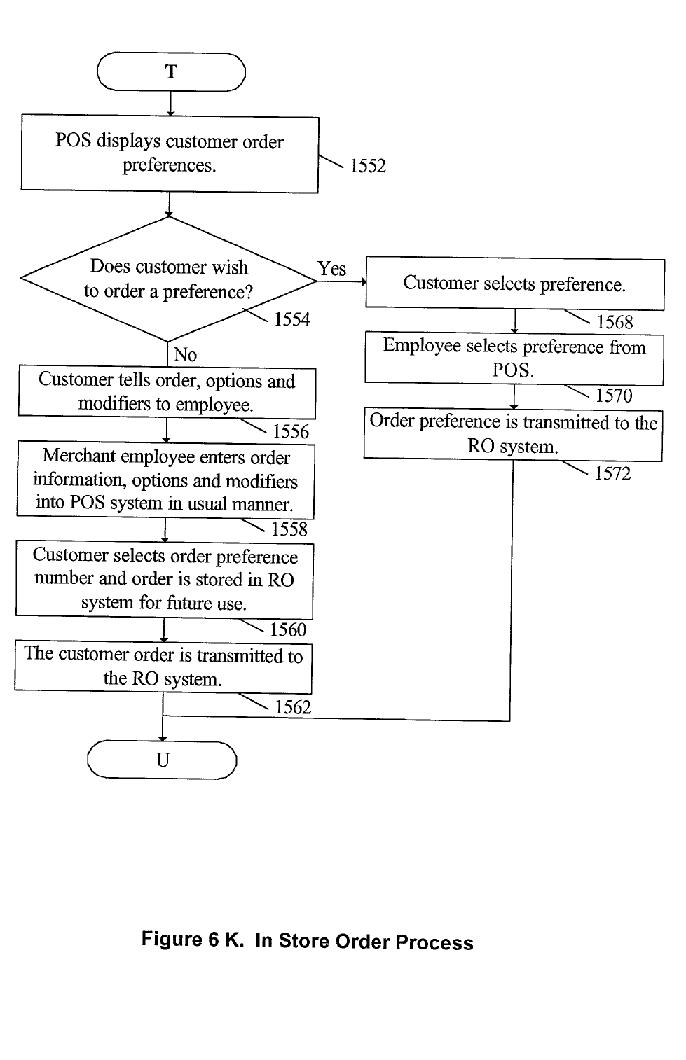

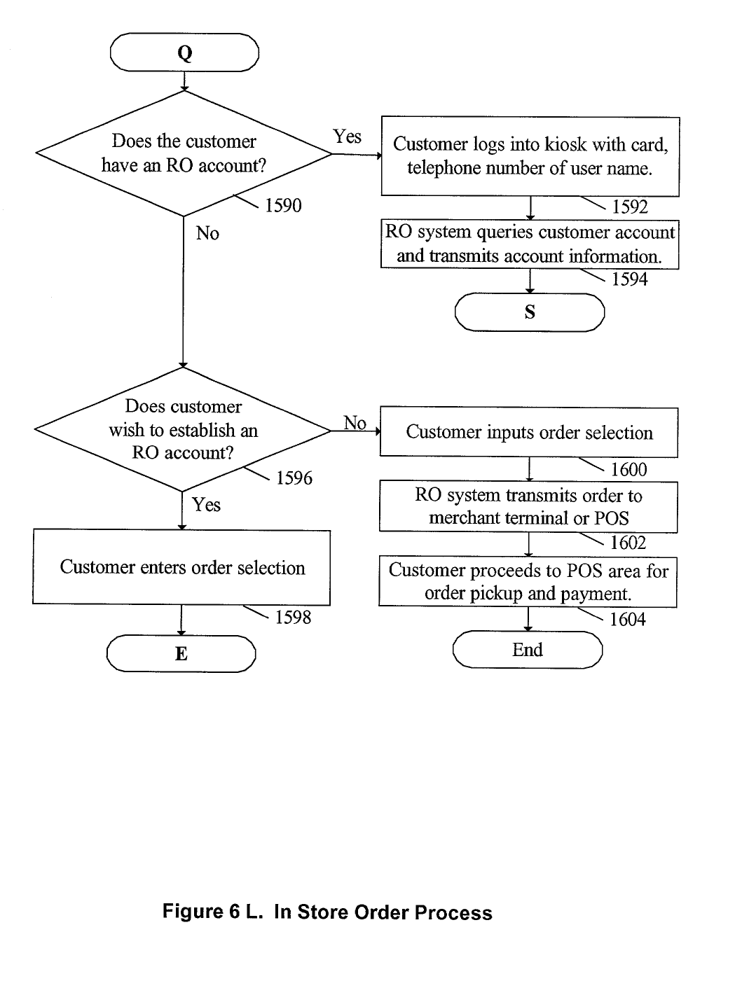

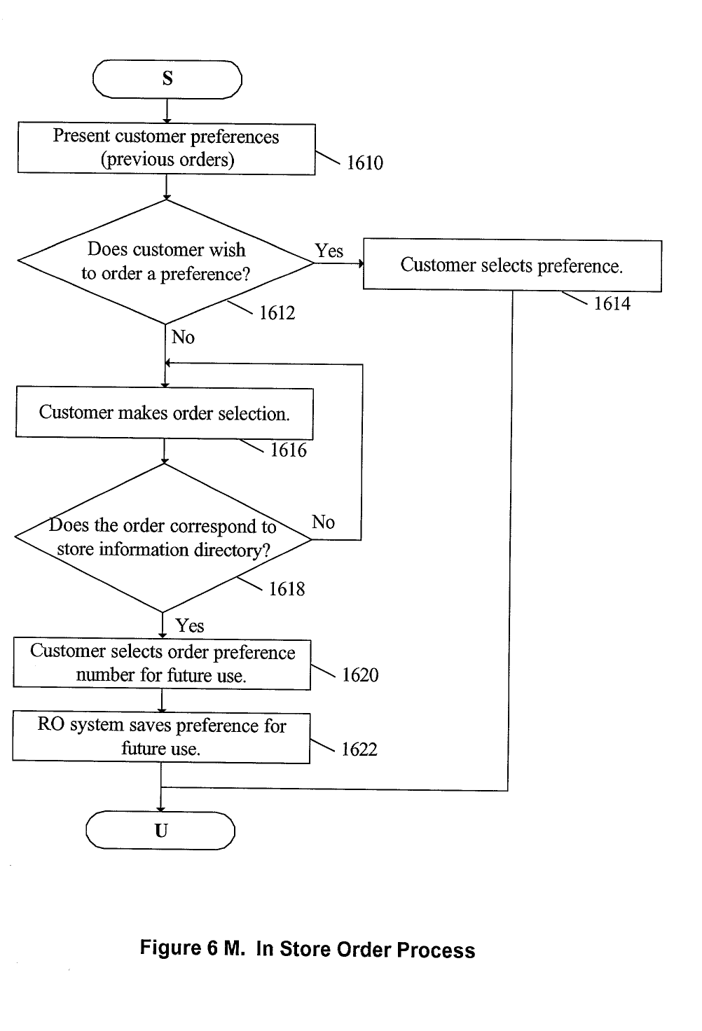

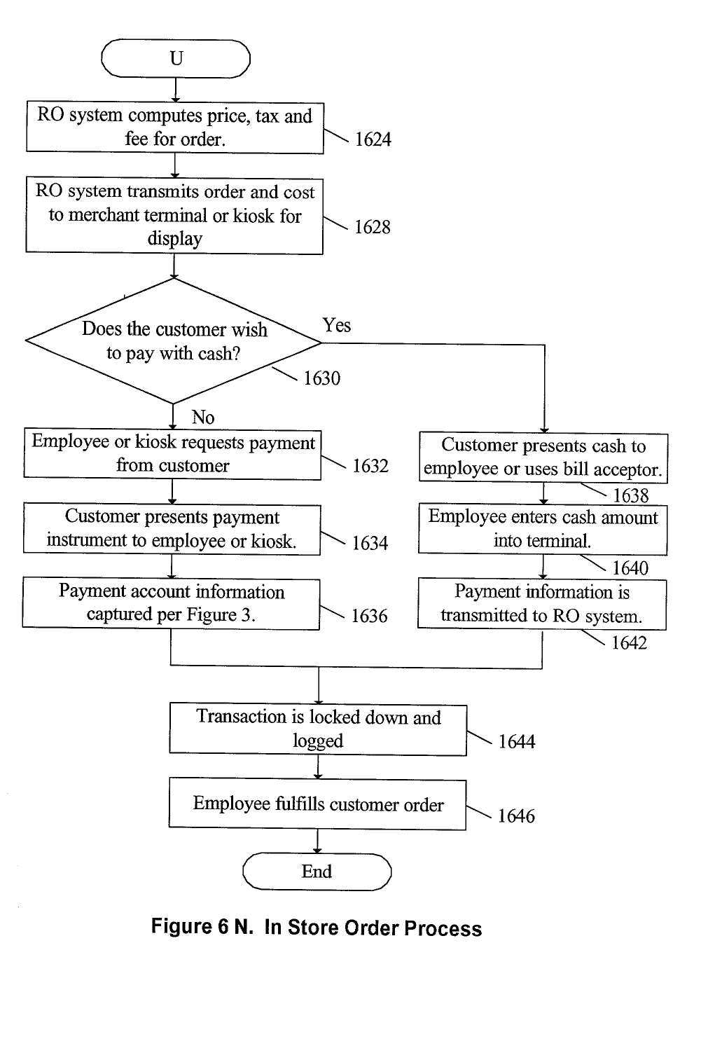

The RO system allows both new and existing customers to place orders, use payment accounts and establish payment accounts while in the merchant's store location. A chart showing the in store ordering processes is presented in FIGS. 6A, 6B, 6C, 6D, 6E, 6F, 6G, 6F, 6G, 6H, 6I, 6J, 6K, 6L, 6M, and 6N. These functions can be accomplished using a variety of merchant IT equipment (50), including the merchant's integrated POS system (1300), an ordering kiosk (1302) or alternatively orders can be placed using a paper form. The ordering and payment functions of the RO system are separated so that the customer can take advantage of either independently or use both together. Payment can be done anonymously (using typical POS processes), can be from an anonymous stored value account (an account with no name attached and funded with cash at the POS) or using electronic payment account information stored by the RO system in the customer account (28). These capabilities maximize the customer's choices and convenience when setting up or using an electronic or remote ordering account. To further maximize customer convince, order information is stored in the customer account (28) for use during subsequent transactions.

Paper Form Orders

When ordering from a paper form, the customer acquires the form from a display in the merchant's store location (1304). Alternatively, the customer can use a form acquired during a previous visit or printed from electronic form (obtained by email or a web site). The customer enters their telephone number onto the form (1306). It will be understood that an email address, device identifier or other unique identifier can be used as an alternative to the telephone number for this purpose and throughout this document without any substantive changes in the invention. The customer then codes (1308) the items they wish to order on the form, along with any options or modifiers (1310). The customer presents the form to a merchant employee (1312). The employee can then scan the form (1314) with a scanner attached to the terminal or POS system (5), from which the encoded order information is transmitted to the RO system through the order delivery system (44). Alternatively, the merchant employee can fax the form to the RO system through a fax server attached to the order delivery system (44) where the coded information is scanned (1316). In yet another alternative, the customer can directly fax the form to the RO system.

Once the information on the form has been captured the store location is extracted (1318) from the form by the order delivery system (44). The store location code can be preprinted on the form. In an alternative embodiment, the order delivery system (44) extracts the store location from the telephone number of the incoming fax call or network identifier of the merchant IT equipment (50). The transaction manager (10) reads the telephone number coded by the customer from the form and determines if there is an error reading the number (1320). The transaction manager (10) then looks up the customer account (28) by telephone number (1322) and determines if this is a new account (telephone number) (1324). If the telephone number is a new one the transaction manager (10) will create (1326) a new customer account (28). The transaction manager verifies (1328) that the items ordered, options and modifiers are available in the store specific information directory (34).

Account Population and Payment

Once the customer account (28) has been established it is populated with customer order preferences and payment information as desired by the customer. The customer communicates with the RO system using their access device (52) connected through the customer access gateway (42), or using the merchant terminal, POS system or self service kiosk (collectively merchant IT equipment 50) connected through the order delivery system (44).

The order information is saved by the transaction manager (10) in the customer's account (28) as an ordering preference (1332). The payment engine (12) computes the price, tax, tip and service fee (1334) for the specific store location using information in the store information directory (36) and merchant account (30). Based on customer choice coded on the form, electronic payment can be used (1336). The customer is given the option (1338) to use a promotional code or account number, which they enter (1340) and is transmitted to the RO system by the merchant IT equipment (50), through the order delivery system (44) to the payment engine (12). The payment engine (12) credits the customer's account for the value of the initial offer (1342). The payment engine computes the price, tax, tip and service fee for the customer's order and transmits the payment amount to the merchant terminal or self-service kiosk (1344) where the amount is displayed. The customer is given the option to establish a stored value account (1346).

If direct electronic payment is being used the payment instrument is requested from the customer (1400). The customer presents the payment (1402) to the merchant employee who scans it on the terminal (50) or the customer uses a card scanner or reader on the self-service kiosk (50). The payment account information is transmitted though the order delivery system (44) to the payment engine (12). The payment engine and transaction manager (10) creates the payment account in the customer account (28) using the process in FIGS. 2A and 2B (1404). The customer identity is verified and the account activated following the process in FIGS. 4A, 4B, 4C, and 4D (1406).

For cash payments the payment engine (12) transmits the payment amount though the order delivery system (44) to the merchant terminal (50) or kiosk (50) where it is displayed for the merchant employee (1408) or customer. The customer presents cash to the merchant employee or inserts the cash into a bill acceptor on the kiosk (50) (1410). The employee enters the cash amount into the terminal (50) (1412). The cash payment amount is transmitted from the merchant terminal (50) or kiosk (50) through the order delivery system (44) to the payment engine (12) (1414). The payment engine (12) enters the cash payment information into the ledger records (32) and logs in the data warehouse (38).

The payment engine (12) transmits a confirmation of the customer's order (1416), if required, through the order delivery system (44) to the merchant terminal (50) where it is displayed and confirmed. Once the order is confirmed the transaction manager (10) saves the preference (1418) for future use as an ordering convince by the customer in the customer account (28). The transaction manager (10) locks down the transaction (1420) by making entries in the merchant account (30), ledgers (32) and logs in the data warehouse (38), and the employee fulfills the customer's order (1422).

Order Error Processing

When an error in a customer order occurs, the transaction manager (10) identifies the error type and creates an informative error message (1430). The message includes information instructing the customer how to fix the error. The error message is transmitted through the order delivery system (44) to the merchant terminal (50) where it is displayed (1432) for the merchant employee and customer. If the customer chooses to correct the error (1434) they fill out another form and submit it to the merchant employee (1436) and the order entry process is repeated.

Subsequent In-Store Orders

Customers have the option to place subsequent orders using previously coded orders saved in the customer account (28) while in the store (or using forms faxed from another location). These orders can be repeat order of previously coded preferences and can be charged to existing payment accounts. Information on orders with new items, options or modifiers is saved as additional order preferences for future customer use.

The order information is transmitted through the order delivery system (44) to the transaction manager (10) where the coded information is extracted (1560) Alternatively, information scanned from the form can be transmitted. The transaction manager (10) verifies (1562) against the store specific information directory (36) that the items, options and modifiers selected are available at the store location. The transaction manager (10) queries the customer account (28) information (1564) using the telephone number or other identifier.

If a preference number for the order has been coded (1566) on the form by the customer the order information is saved with that number (1568). If no preference is coded the order information is saved as the first preference in a list (1450) as a default. The order information is saved (1452) by the transaction manager (10) under the preference number for the future ordering convenience of the customer in the customer account (28).

The payment engine (12) computes the price, tax, tip and service fee for the order (1454) using information in the merchant account (30) and the store information directory (34). The payment is processed using the process shown in FIGS. 5A, 5B, 5C, and 5D (1456). The payment authorization is transmitted (1458) through the order delivery system (44) to the merchant terminal (50) where it is displayed for the merchant employee. If the payment requires a signature for authorization (1460) the customer is presented with and signs the authorization slip or places a signature on a tablet for digital capture (1462). The merchant terminal (50) prints the signature slip. The signature slip is archived or the digital signature is archived (1464) in the data warehouse (38). The employee enters a verification or confirmation code (1466) into the merchant terminal (50), which transmits the verification code to the payment engine (12) through the order delivery system (44) where it is stored in the data warehouse (38). The transaction manger (10) then locks down the transaction (1468) and makes the required entries in the ledgers (32) and logs in the data warehouse (38). The employee fulfills the customer order (1470).

Establishing a Stored Value Account

The RO system supports options for the customer to establish, fund and use a stored value account for payments. The stored value account are established, funded and used either electronically (generally from a remote location) or in person at the point of sale. Funding of the account at the point of sale can be in cash, check or using an electronic means.

When the customer initiates establishing a stored value account they are offered the option of funding with cash or electronically (1480). When the customer wishes to fund with cash, they proceed to the POS and present cash (or check) to the merchant employee (1488). The employee enters (1490) the cash amount taken into the merchant terminal (50), which transmits (1492) the cash amount to the stored value processor (16) through the order delivery system (44).

If electronic funding is to be used, the customer can perform the funding using a wired or wireless access device (52), at a self-service kiosk (50) in the store or at the POS using the merchant IT equipment (50). The customer chooses the initial funding amount (1482). The funding account information is captured (1484) using the process shown in FIGS. 2A and 2B or FIGS. 3A and 3B and the customer's identity is verified and the account is activated (1486) using the process shown in FIGS. 4A, 4B, 4C, and 4D.

Once the account is funded the stored value processor (16) establishes (1494) the customer's stored value account in the customer account (28) and makes the required entries in the ledgers (32), logs in the data warehouse (38), and debits (1496) the account for the amount of the purchase if any. The payment confirmation (1498) is logged by the stored value processor and sent to the merchant terminal (50).

Optionally, the merchant employee can activate a stored value magnetic or smart card (1500) for the customer as has previously been discussed.

Orders with Integrated POS System

Employees can assist customers in creating accounts, for making electronic payments with their accounts and ordering goods and services using an integrated POS system (50). The integrated POS system communicates order and payment information directly with the RO system over a data network through the order delivery system (44).

When the customer places an order with a merchant employee they have the option (1510) to use or establish a remote ordering account. If they choose not to use an RO account their order and payment is processed in the conventional manner (1512) following the merchants normal procedures.

If the customer does wish to use an RO account the merchant employee asks the customer for their telephone number or other identifier (1514), which the employee enters (1516) into the POS terminal (50). The POS terminal transmits the identifier information through the order delivery system (44) to the transaction manager (10) where a query of the customer account (28) database is made to determine if the customer already has an account. The RO system transmits the customer account information (if any) to the POS system.

If this is a new customer (1518), the customer dictates their order to merchant employee (1520), who enters the items ordered along with options and modifiers into the POS system (50) (1522) following normal POS procedures. The POS system then transmits the order information and telephone number to the transaction manager (10) (1524) through the order delivery system (44). The order delivery system extracts the store location (1526) either from data coded in the message or from the network address or dial connection number used.

The payment engine (12) then computes the order price, tax, tip, and service fee (1528). The payment engine transmits the payment amount through the order delivery system (44) to the POS system where the information is displayed (1530). The customer is given the choice of paying with cash or electronically. If the customer chooses cash the payment is processed and order fulfilled in the manner already described (1408, 1410, 1412, 1414, 1416, 1418, 1420, 1422). If the customer chooses electronic payment, the payment is processed and the order fulfilled in the manner already described (1400, 1402, 1404, 1406, 1416, 1418, 1420, 1422).

The ordering preferences (based on pervious orders stored in the customer account 28) for recurring customers are displayed on the POS system (50) (1552). If the customer wishes to order a preference (1554) the customer tells the employee their preference (1568) and the employee enters the choice into the POS system (1570). The POS system transmits (1572) the order preference to the transaction manager (10) through the order delivery system (44).

If the customer wishes to place a new order they tell the merchant employee which items, options and modifiers they wish to order (1556). The merchant employee enters the customer order into the POS system (50) (1558). The customer then selects a preference number for this order, which the employee enters into the POS system (1560). The order and preference number is transmitted from the POS system, through the order delivery system (44) to the transaction manager (10) (1562), which saves the preference and order information in the customer account (28).

Payment is processed and the order fulfilled following the in store payment process to be described below.

In-Store Kiosk Order

Customers can create accounts, place orders and make payments using the RO system through a self-service kiosk (50) at the merchant's store location. The kiosk can be equipped with a magnetic card or smart card reader for electronic payment and a bill acceptor for cash payment. As has already been described, customers can use the self-service kiosk to create and fund stored value accounts.

If this is the customer's first use of the system (1590) the customer is asked if they wish to create a remote ordering account (1596). If they do not wish to create an account the customer enters their order selection (1600) using the interface on the kiosk (50). The kiosk transmits the order to the order delivery system (44), which transmits (1602) the order to the merchant terminal (50). No transaction processing by the RO system is required. In an alternative embodiment, the kiosk can directly transmit order information to the merchant terminal or POS system. The customer proceeds to the point of sale (1604) for order pickup and payment.

If the customer does wish to create a remote order account the customer enters their order (1598), including items (goods or services), options and modifiers, into the interface on the kiosk (50). The order is transmitted to the transaction manager (10) through the order delivery system (44). The processing and the payment for in-store initial orders has already been described and starting at item 1334 on FIG. 6C.

Recurring customers log into the kiosk (50) (1592) by entering a telephone number, a user name or other identifier or using a magnetic card, bar-coded card, or smart card. The kiosk (50) transmits a request through the order delivery system (44) to the transaction manger (10) to query customer account (28) records (1592) and then transmits account information back to the kiosk. The kiosk presents the customer's ordering preferences (1610) to the customer. If the customer wishes to use a preference (1612) the customer selects the preference (1614) of choice. The preference selection is transmitted to the transaction manager through the order delivery system.

Alternatively, the customer can make a new order selection (1616) (for goods and services) including items, options and modifiers, using the interface on the kiosk (50). The kiosk transmits the order though the order delivery system (44) to the transaction manager (10). The transaction manager (10) verifies through the location specific store information directory (36) that the order corresponds to the items, options and modifiers are available at that location. If there is an error, the error is transmitted back to the kiosk and the customer asked to correct the error. Once the order is accepted the customer is asked to assign a preference number to the order for future use (1620), which is transmitted through the order delivery system (44) and saved by the transaction manager (10) (1622) in the customer account (28). Payment and order fulfillment for in-store orders for existing customers are discussed in the next section.

In Store Payment Process

The RO system offers customers with RO accounts multiple payment options while they are in the merchant's store location. These choices include credit cards, debit cards, checks, cash, and stored value accounts managed by the RO system. These payments can be made through a merchant employee at the POS merchant IT equipment (50) or at a self-service kiosk (50).

The transaction manager (10) receives t the order and passes it to the payment engine (12) which computes the price, tax, tip and service fee for the customer's order (1624). The payment engine (12) then transmits the payment request and order (if required) to the merchant terminal or kiosk (50) (1628) through the order delivery system (44).

The customer is given the option to pay with cash (1630). The customer presents cash to the employee or places cash into the kiosk (50) bill acceptor (1638). If the employee is processing the payment they enter the cash amount into the terminal (50) (1640). The payment information is transmitted (1642) through the order delivery system (44) to the payment engine (12), which makes appropriate ledger (32) and log entries in the data warehouse (38).

If electronic payment is to be used, the merchant employee or kiosk (50) requests payment (1632) from the customer. The customer presents the payment instrument to the employee or swipes the payment card with the kiosk (1634). The electronic payment is then processed following the flow shown in FIGS. 5A, 5B, 5C and 5D.

Once the payment process has been completed, the transaction manager (10) locks down the transaction (1644), making the required ledger (32) and log entries in the data warehouse (38). Once payment authorization has been received at the terminal (50), the merchant employee fulfills the customer's order (1646).

Telephone Order Process

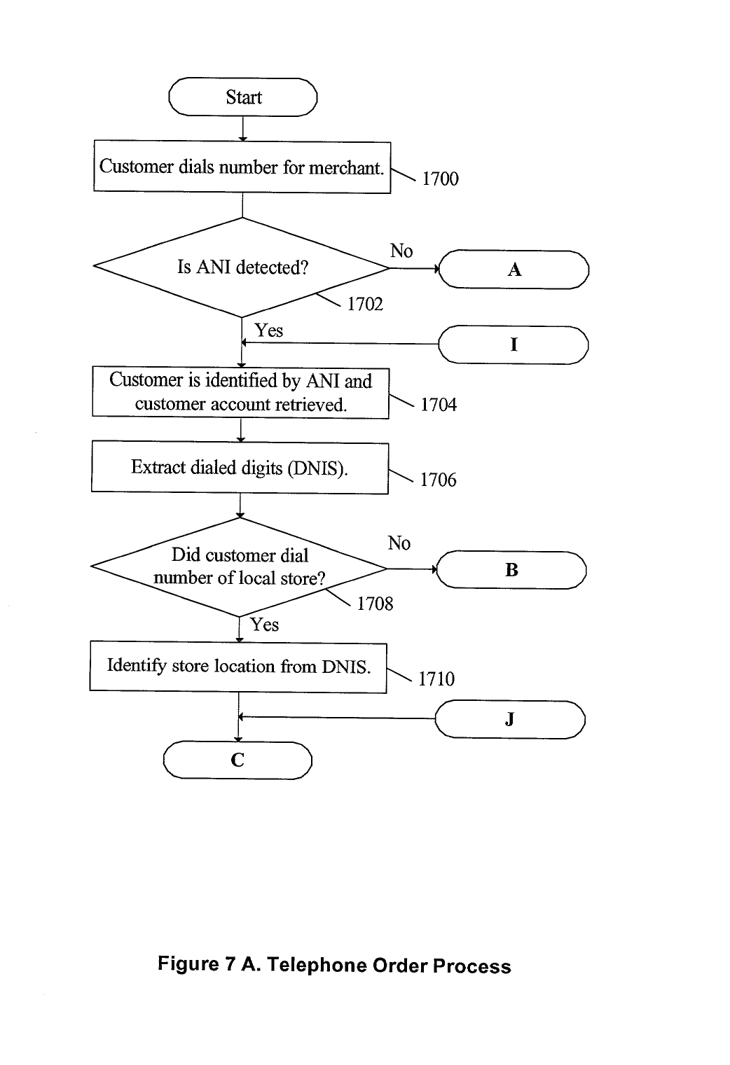

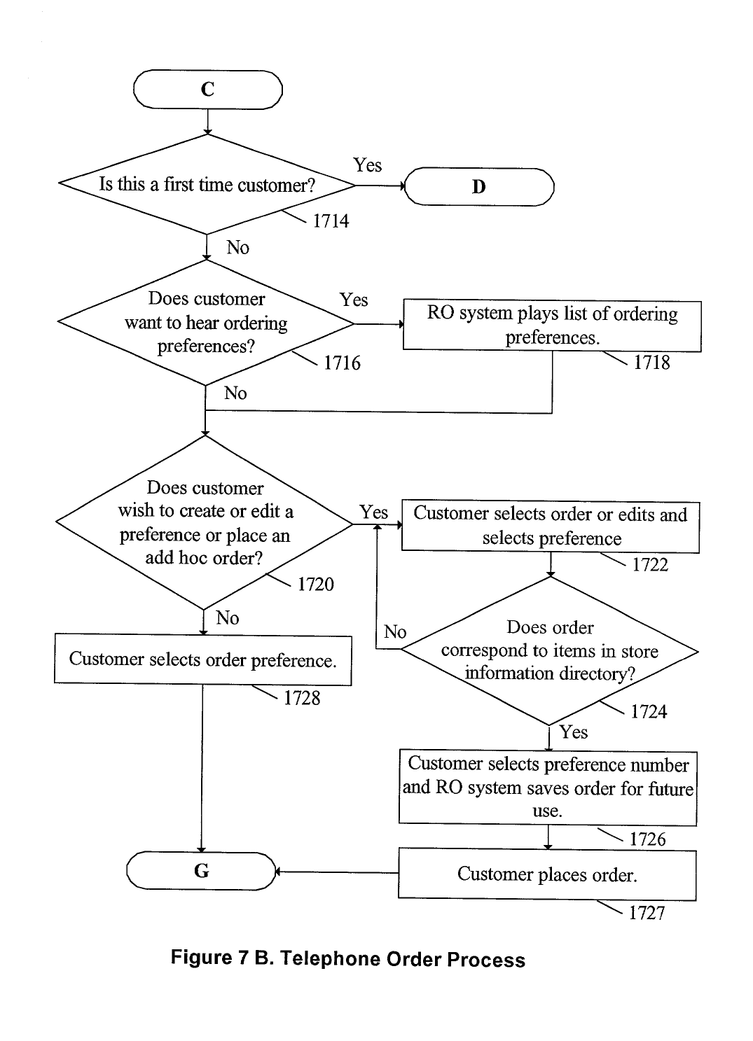

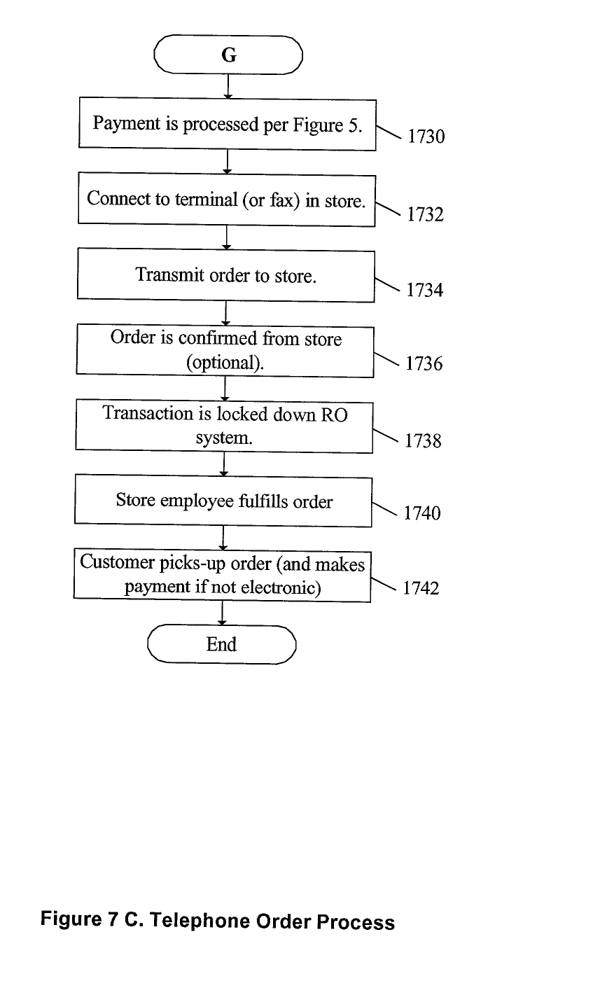

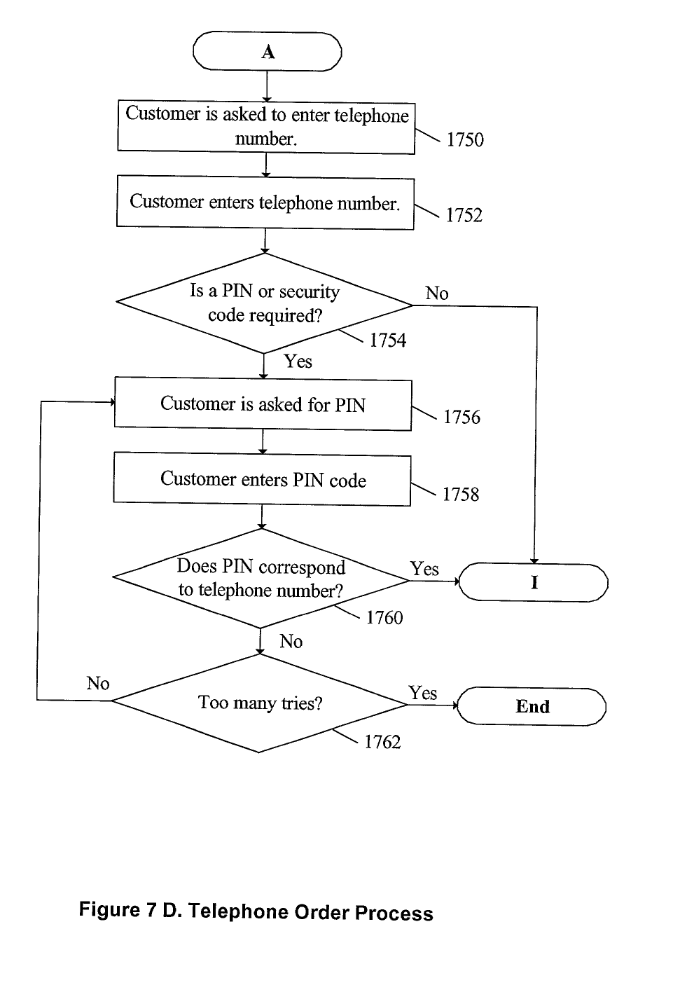

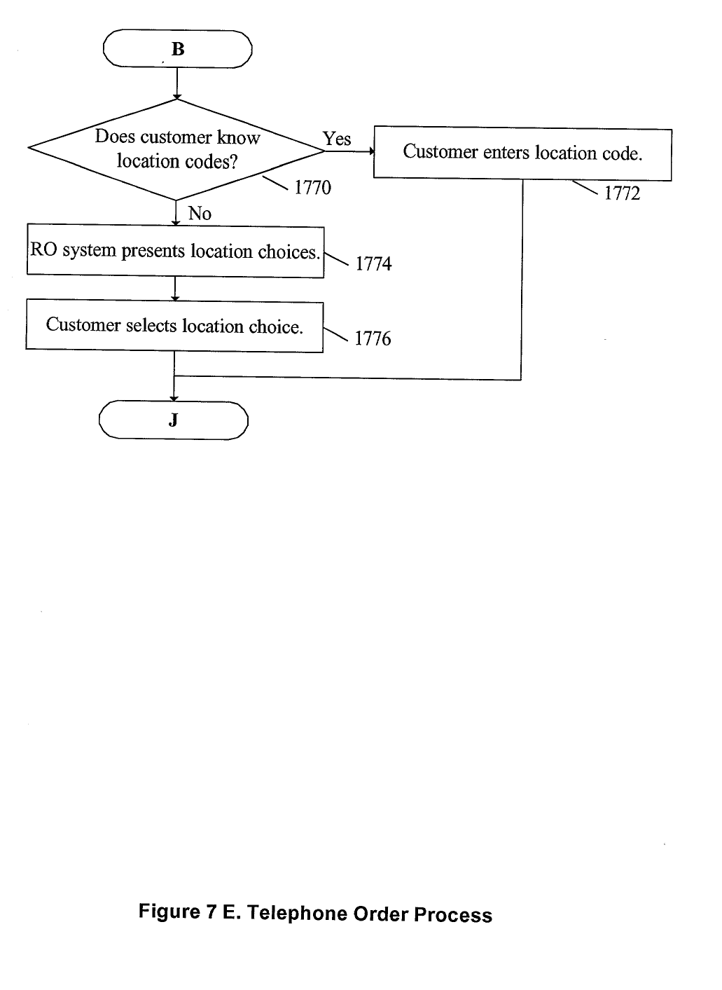

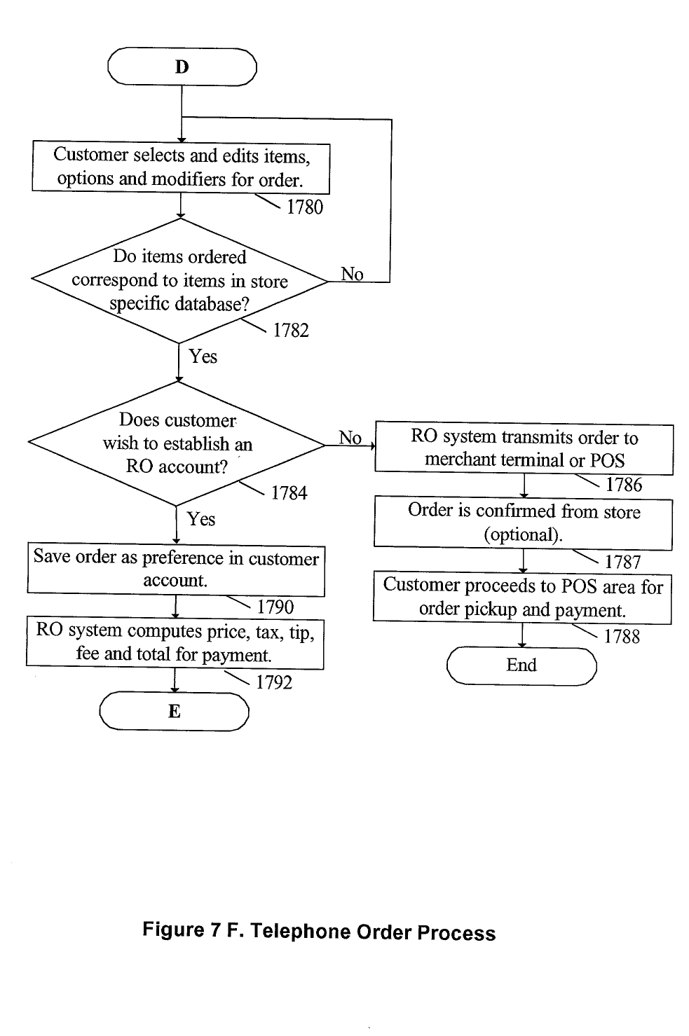

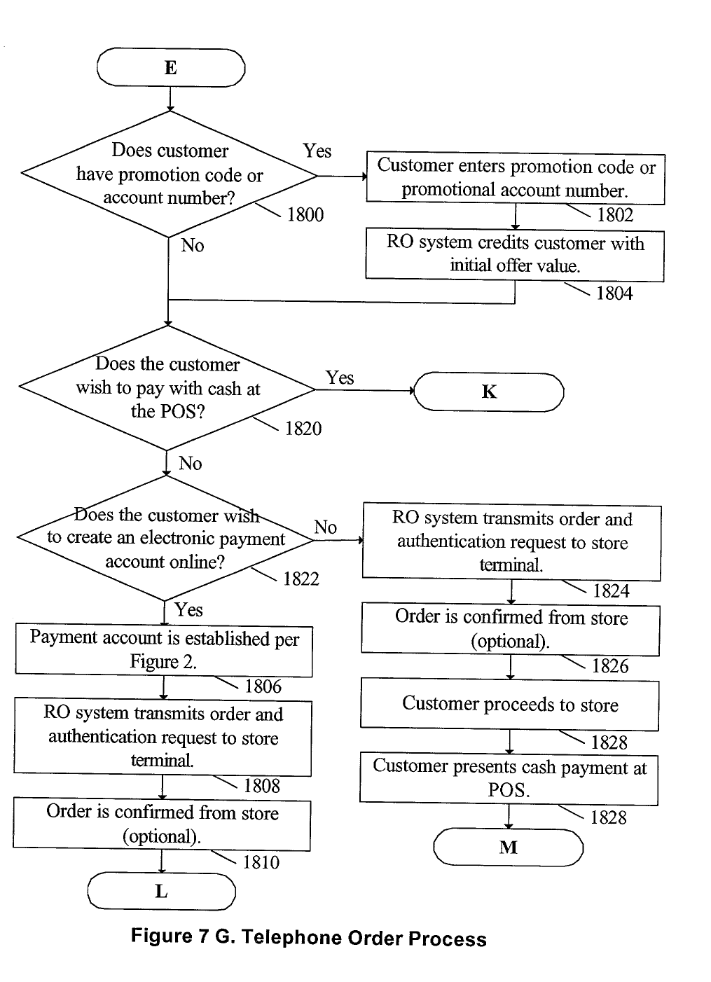

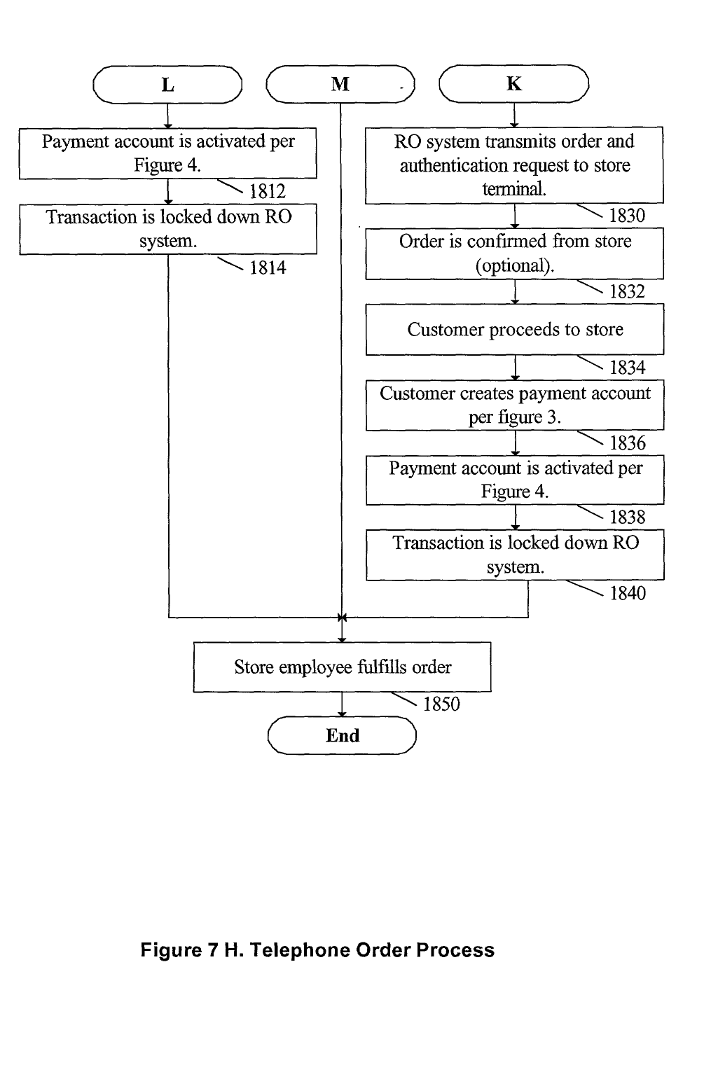

The RO system provides customers with multiple options for creating accounts, placing remote orders, and performing payment electronically. This section explicitly describes the process followed for account creation, ordering and payment by customers using a wired or wireless telephone. Customers can use a variety of access devices (52) for access to the RO system, including wired and wireless Internet devices and wired and wireless telephones. Alternatively customers can use wired or wireless short message devices (e.g. two-way pagers), devices supporting the Short Message Service (SMS) or an IM system. Electronic connections to the customer access gateway (42) can be used from a remote location or while the customer is at the merchant's store location. The basic telephone order process flow is shown in FIGS. 7A, 7B, 7C, 7D, 7E, 7F, 7G and 7H. A local area wireless base station can be used for connections at the store location. It will be clear to those skilled in the art that the processes and functions discussed here will be nearly identical if the customer were using a wired or wireless interface device or other electronic interface device.

Connection and Store Identification

When a customer wishes to place an order or perform another operation through the RO system they dial a merchant number (1700). The customer access gateway (42) attempts to detect the customer's telephone number (using Automatic Number Identification, ANI, or other methods) (1702). The transaction manager (10) then identifies the customer and queries the customer account (28) (1704).

The customer access gateway (42) extracts the dialed digits (1706) (using the Dialed Number Indication System, DNIS, or other method). The transaction manager (10) determines if the number dialed corresponds to a local store number (1708) and if so uses this information to identify the location (1710).

If the customer access gateway (42) is not able to identify the customer's ANI (1702), the customer is asked to enter their telephone number (1752). If a PIN or security code is required (1754) the customer is asked to enter their PIN (1756). The customer enters the PIN (1758) and the security manager (18) verifies that the code is correct (1760) by querying the customer account (28) or the security information store (34). If the there is not agreement, and if the customer has not made too many tries (1762), the customer can repeat the process. The number of tries allowed is dependent on the merchant's and system operator's business rules. It should be clear that a log in procedure using user name (or other identifier) and password (or other security credential) can be used as an alternative, with the best choice depending on the characteristics of the user's interface device.

If the customer has not dialed a number specific to a specific store location (1708) and if the customer is not using a preference which includes location, the customer must select a store location for their order. If the customer knows a store location code (1770) or other identifier they can enter it (1772). If not, the transaction manager (10) will present location choices (1774) through the customer access gateway (42) and the customer can select the location of interest (1776). It will be understood that the same process is used with data connections; only the format of the user interface is different.

Ordering Process

The transaction manager (10) determines if this is the customer's first use of the system (1714) (or does not have a customer account 28). Recurring customers are given the option of hearing their ordering preferences (1716), and if so, the customer access gateway (42) presents (1718) these preferences.

The customer is given the option to create a preference, edit an existing preference or place an ad hoc order (1720). The customer then selects or edits (1722) the items, options or modifiers of choice for the preference or order. The order and preference are transmitted through the customer access gateway (42) to the transaction manger (10) verifies (1724) through the specific store information directory (34) that the items, options and modifiers in the order correspond to the offerings at that location. If not, the customer is asked to edit the order. If the customer is creating a new preference, they are asked to assign a number to this preference (1726). The transaction manager (10) saves this preference in the customer account (28) under the number specified. The customer then places the order (1727). If the customer desires (1720) they can select an order preference (1728) directly. In either case the order or preference is transmitted through the customer access gateway (42) and passed to the transaction manager (10) for processing.

It will be understood that the same processes described in this section can use data connections as an alternative; only the format of the user interface is different.

Payment and Order Fulfillment

Once the customer has placed an order their payment is processed flowing the flow shown in FIGS. 5A, 5B, 5C, and 5D (1730). Once the payment process is complete, the order delivery system (44) connects to the merchant's terminal (50) (1732) in the store and transmits the order (1734) and payment authorization. In an alternative embodiment, the order delivery system (44) can connect to and transmit the order through an integrated POS system (50) or a fax machine. Once the order has been transmitted, the merchant employee confirms (1736) the receipt of the order. The confirmation is transmitted through the order delivery system (44) to the transaction manager (10), which locks down the transaction (1738) and makes the required ledger (32) and log entries in the data warehouse (38). The merchant employee fulfills the order (1740) and the customer picks up the order (1742).

First Time Customer Order and Payment

When a customer is identified as a first time user (1714) the customer initiates the creation of an RO account by selecting and editing items, options and modifiers for their initial order (1780). The order information is transmitted through the customer access gateway (42) and passed to the transaction manger (10), which verifies (1782) through the specific store information directory (36) that the items, options and modifiers in the order correspond to the offerings at that location. If not, the customer is asked to edit the order.

The customer is given the option to create an RO customer account (28) (1784). Alternatively, customer can choose to simply place an order without creating an account. In this case the order delivery system (44) connects to the terminal (50), POS (50) or fax at the merchant location and transmits the order to the store (1786). The merchant employee can confirm the receipt of order (1787) if required. The customer then proceeds to the store, makes the payment in a conventional manner, and picks up their order (1788).

If the custome3r wishes to establish an RO account they can save their initial order as a preference (1790) for convenient ordering in the future. The transaction manager (10) saves the order preference information in the customer account (28). The payment engine then computes the price, tax, tip and service fees (1792) for the order. The customer is given the opportunity (1800) to enter a promotion code or promotional account number (1802). Once the code or account number is entered the payment engine (12) credits the customer's payment (1804).

The customer is asked if they wish to pay with cash (1820). If so, the RO system transmits (1830) the order through the order delivery system (44) to the merchant IT equipment (50), where an employee can confirm (1826) the order if required. The printed or displayed order includes an indicator that payment must be taken before the order is fulfilled. The customer then proceeds to the store (1828), pays the employee at the POS (1828) and the employee fulfils the order (1850). In the case of customer payment at the POS no payment account information needs to be collect and a payment account does not need to be activated.

The customer is asked if they wish to create a payment account online (1822). In this case, the customer's payment account is established following the process shown in FIGS. 2A and 2B (1806). The order delivery system (44) transmits the order and request to authenticate the customer (1808) to the merchant terminal (50) or POS system. If required, a merchant employee confirms (1810) the receipt of the order. When the customer arrives at the store the merchant employee verifies the customer identity and activates their account following the process shown in FIGS. 4A, 4B, 4C, and 4D (1812). Once the payment account is activated, the merchant terminal transmits the confirmation through the order delivery system (44) to the security manager (18), which activates the account (28). The transaction manager (10) locks down the transaction (1814) and makes the necessary ledger (32) and log entries in the data warehouse (38). The merchant employee then fulfills the customer's order (1850).

The customer can take the option of both creating and activating an electronic payment account at the merchant's store location. This process has the clear advantage of minimizing the amount of information that must be collected remotely through manual entry. Once the customer selects this option, the RO system transmits (1830) the order through the order delivery system (44) to the merchant IT equipment (50), where a merchant employee confirms (1830 it, if required. The customer then proceeds to the merchant's store location (1834) and creates (1836) a payment account using the process shown in FIGS. 3A and 3B The customer's identity is verified and the payment account activated (1838) using the process shown in FIGS. 4A, 4B, 4C, and 4D. The RO system signals the activation of the account to the merchant IT equipment (50) and locks down the transaction (1840). The merchant employee then fulfills (1850) the customer's order.

It will be understood that the same processes described in this section can use data connections (rather than a telephone connection) as an alternative; only the format of the user interface is different.

Initial Offer Process

To promote use of the remote ordering service, first time customers may be offered one or more initial promotional offers for trying the remote ordering service. These promotions are offered without the need for a customer to enter payment account information or any identity information, thus speeding the process for the first time user and limiting the customer's risk and obligations. Once the customer has seen the value of the service, they can signup for the different levels of regular ordering and payment account capabilities. The basic order and fulfillment process follows the general flow already discussed in this documents, in for example FIGS. 6 and 7. It will be clear to those skilled in the art, that the same process can be followed using a data interface such as a Short Message Service (SMS), an IM system, the World Wide Web or two-way pagers.

An offer process can also be used to remove the burden of manually entering certain customer account (28) information. The customer account can be pre-populated using the same marketing databases (58) (or complementary databases) used to create and distribute the offers.

No Obligation Introduction

The RO system supports a no-obligation introductory offer to walk-in customers at the merchant's location. This method does not require the advanced distribution of coupons or other information. When the customer arrives at the merchant's location they connect with their wireless access device (52) to the remote order system through the customer access gateway (42). Depending on the type of connection, the customer access gateway will capture the customer's telephone number (usually using ANI), data device ID or email address. As an optional security measure the customer may be asked for to enter an identifier to use when picking up their order. Minimal identifier information is collected to keep the process as anonymous as possible.

Once connected the customer enters their order. Orders can be placed in a number of ways including at least the following:

1. Selecting items of choice from numbers shown on the merchant's menu board typically using an Interactive Voice Response (IVR) system,

2. selecting products by number from a printed brochure typically using an IVR system,

3. selecting items by stating their names using an Automatic Speech Recognition (ASR) system, and

4. browsing an on-line product catalog using either a data interface such as the World Wide Web, using either IVR or ASR methods or the self-service kiosk (50).

It will be clear to those skilled in the art that a combination of the above methods can be used. It will also be clear that the above techniques can be used for subsequent orders as well.

The order is transmitted through the customer access gateway (42) to the transaction manager (10). The transaction manager verifies that this is an initial order by querying the telephone numbers of other identifiers stored in the customer account (28). The transaction manager verifies that the items, options and modifiers selected are available at that store location by querying the location specific store information directory (36). If there is an error the customer is asked to edit their order. The transaction manager then passes the order to the merchant terminal (50) through the order delivery system (44) where it is printed or displayed by the merchant employee.

The first time customer picks up the order or has it delivered in the usual manner previously described using the telephone number or device ID as an identifier. Pickup can be in the store, at the curb or in a drive through.

The transaction manager (10) creates a provisional customer account (28) with the identifier and the initial order. This information will be used when the customer wishes to establish some type of regular account. The transaction manager creates required entries in the merchant account (30), ledgers (32) and logs in the data warehouse (38) for use in settlement of the promotional expenses with the merchant location.

Promotional Payment Accounts

In an alternative embodiment, a first time customer uses a one-time use payment account to place an initial order. In this case the order processes discussed above and shown in FIGS. 6 and 7 are followed, with the exception that the promotional payment account number is used for an electronic payment (instead of the customer's actual debit or credit account number). The promotional payment account uses the familiar 16-digit format used for credit and debit accounts but with the Bank Identification Number (BIN) or other coding set to indicate this is a promotional account. The payment engine (12) or payment switch (14) recognizes that the payment is using a promotional account, in which case the customer will not be asked for typical payment account information, such as account holder name, address, etc.

The first time customer picks up the order or has it delivered in the usual manner previously described using the telephone number, a device ID or an identifier selected by the customer as an identifier. Pickup can be in the store, at the curb or in a drive through.

The transaction manager (10) creates a substantially anonymous provisional customer account (28) with the identifier and the initial order. This information will be used when the customer wishes to establish some type of regular account. The transaction manager creates entries in the merchant account (30), ledgers (32) and logs in the data warehouse (38) for use in settlement of the promotional expenses with the merchant location.

It will be clear to those skilled in the art, that the process discussed in this section can use other types of promotional codes and that gathering payment account information is not required.

Communication of Promotion Codes and Accounts

Prospective customers can receive trial promotional codes or payment account numbers in a variety of ways. These numbers can be posted at the merchants store location, can be available on printed brochures available at store locations or other locations, or displayed in print or electronic media advertisements.

In the preferred embodiment existing customers distribute the promotional codes or payment account numbers. The customers connect their access devices (52) to the customer access gateway (42). Customers enter contact information for people they know, whom they believe will be interested in the service. The contact information can include mailing address, email addresses or telephone numbers. The transaction manager (10) makes entries into the customer accounts (28) of the contact information each existing customer has supplied. The transaction manager then creates messages containing the promotional codes or payment account numbers, which are transmitted (via mail, email, IM, SMS, or voice mail) to the prospective customers through the customer access gateway (42). When prospective customers respond to the offer and enter the codes the payment manger queries the customer accounts to determine who referred the prospect and adds promotional credit to that customer's promotional account. The referring customer will be notified through the customer access gateway of the promotional value they have earned. This notification can be done in real-time when the credit is earned, or the next time the customer connects to the system for some other purpose.

In another embodiment, first time customers make their first contact with the customer access gateway (42) using a promotional telephone number or Universal Resource Locator (URL). Using this type of special connection eliminates the need for the customer to remember or enter promotional codes or payment account numbers all together.

Promotional Coupons

The RO system provides methods for customers to rapidly create accounts using paper-based coupons. This method reduces to an absolute minimum the amount of information that either the customer or the merchant needs to collect and enter. The merchant distributes the coupons using targeted marketing methods. Suitable targeted marketing direct mail methods for distributing coupons and introductory offers to customers most likely to respond to them are well know. The distributed coupons contain information on the service and state an introductory promotional offer the prospective customer can take advantage of. The coupons include coded information on the promotional offer and promotional code. In addition, the coding can include customer specific information derived from marketing databases (58) including name, address, email address, and telephone number.

When the customer arrives at the merchant's location, they present the coupon to the merchant employee who scans the coupon using suitable peripherals attached to the merchant IT equipment (50). Alternatively, the customer can scan the information at the self-service kiosk (50). In this case, the customer enters an identifier.

The scanned information is transmitted through the order delivery system (44) to the transaction manger (10). The transaction manager creates a new customer account (28) entry using the information coded on the coupon. The promotional information coded on the coupon is passed to the payment engine. The transaction manager (10) transmits the confirmation of the account creation through the order delivery system (44) to the merchant terminal (50) where it is displayed or printed. The merchant employee asks the customer for a telephone number, email, or user name, which the employee or the customer then enters into the merchant terminal (50). The identifier information is transmitted through the order delivery system (44) to the transaction manager (10), which adds the information to the customer account (28) (if this has not already been done). Once the customer account has been established the customer can place an order using any of the methods discussed in this document. The payment engine (12) applies the promotional discount and processes the payment using any of the methods discussed in this documents. If required, payment account information can be collected manually or electronically with the merchant terminal (50) or self-service kiosk as has already been described. Once the order has been entered and payment processed, the transaction manager (10) transmits an authorization through the order delivery system (44) the merchant terminal (50). The merchant employee then fulfills the customer's order.

Most any paper-based coding and scanning technology can be employed. Suitable coding and scanning technology include bar codes read with bar code scanners, printed characters read with an optical character recognition peripheral, or magnetic ink read with a magnetic ink scanners (such as are used for check draft capture). In an alternative embodiment, the paper coupon can be faxed to the remote order system, where the order delivery system (44) reads the encoded information and transmits it to the transaction manager (10).

In an alternative embodiment the coded coupon is presented to the customer electronically. The electronic coupons can be distributed using a suitable targeted email database (58) for example. Suitable delivery methods include an (html) email or a customized web page. The electronic documents is printed by the customer and brought to the merchant's store location. The process of creating the customer account then follows the process already described.

Introductory Offers with Pre-Populated Accounts

The RO system provides methods to create a customer account (28) using information that is pre-populated into that database. This method reduces to an absolute minimum the amount of information that either the customer or the merchant needs to collect and enter. The transaction manager (10) loads the information in batch to the customer account (28) from marketing databases (58) or other databases (58) containing likely prospects such as customer lists of the merchant or related merchants. The information read by the transaction manager (10) from these databases (58) can include, name, address, telephone number, email address, etc.

The same databases (58) used to populate the account or separate specialized databases (58) are used to address the offer messages for transmission to prospective customers. Suitable transmission means include paging message, email, SMS message or IM message. These messages will generally contain information on the service and an introductory promotional offer to the customer. The message contains a unique identifier that is used to identify the customer during account creation. When the customer receives one of these messages they can electronically initiate creation of an account, but without the need to enter the information already available. The customer uses their access device (52) to connect to the system through the customer access gateway (42). Once connected, and if it cannot be done automatically, the customer enters the unique identified, which the transaction manager (10) uses to identify the customer account (28) information used to create the new account. With a telephone connection the customer telephone number is automatically collected by the customer access gateway (42) using the ANI or other available means. With a World Wide Web connection a unique URL (includes the unique identifier in the URL) can be used to identify the customer. Either of these methods saves the customer the need to enter the unique identifier manually. Depending on the type of connection type and capability, the customer will be asked to enter an account name or alias. The identifier information is transmitted through the order delivery system (44) to the transaction manager (10), which adds the information to the customer account (28) and creates the required entries. Once the customer account has been established the customer can place an order using any of the methods discussed in this document. The payment engine (12) applies the promotional discount and processes the payment using any of the methods discussed in this documents. If required, payment account information can be collected manually or electronically as has already been described in this document. The rest of the process for account creation and activation will follow the processes already discussed in this document.

Alternatively the unique identifier can be coded on a printed document or coded in an electronic document that is printed by the customer. The same database (58) used to populate accounts or a special purpose database (58) is used to address these messages to the prospective customers. The messages are sent to the prospective customers based on these addresses. Interested customers take the printed documents to the merchant's location where the account is created using the process described in the previous section with the exception that customer specific information is available in the database (58) rather than scanned from the form.

In an alternative embodiment the transaction manager (10) uses a real-time network connection to the databases (58). When a customer wishes to create an account the transaction manager queries the external databases (58) to retrieve the required information. The transaction manager then places this information into the customer account (28). The account creation process then follows the flow discussed in this section.

We claim:

1. A method for establishing a customer account in an electronic remote ordering system wherein order fulfillment is accomplished upon the customer's attendance at a merchant location, comprising:
creating a provisional customer account contemporaneous with said customer placing an initial order through said remote ordering system for fulfillment at a specific merchant location;
delivering said initial order from said remote ordering system to said specific merchant location; and,
activating said customer account upon or after said customer's attendance at said specific merchant location for fulfillment of said initial order.

2. The method of claim 1 wherein:
said step of creating a provisional customer account comprises creating or receiving a customer account identifier; and,
said customer account is activated upon said customer's attendance at said specific merchant location for fulfillment of said initial order, and without collecting further information from said customer upon said attendance.

3. The method of claim 2 wherein said customer effects payment for said initial order without delivering further information identifying said customer.

4. The method of claim 1 further comprising the step of:
establishing a stored value account for said customer and enabling payment of said initial order or of subsequent orders from said stored value account.

5. The method of claim 4 further comprising the step of recording the input of funds into said stored value account following the non-electronic receipt of funds from said customer.

6. The method of claim 4 wherein:
said step of creating a provisional customer account comprises creating or receiving a customer account identifier; and,
said customer account is activated upon said customer's attendance at said specific merchant location for fulfillment of said initial order, and without collecting further information from said customer upon said attendance.

7. The method of claim 1 wherein:
said step of creating a provisional customer account comprises creating or receiving a customer account identifier; and,
further comprising the step of collecting further information relating to said customer.

8. The method of claim 7 wherein said further information comprises payment account information.

9. The method of claim 7 wherein said further information is captured from at least one means of payment or payment credential tendered by said customer upon attendance at said specific merchant location for fulfillment of said initial order.

10. The method of claim 9 wherein said means of payment or payment credential is an electronic payment credential selected from the group comprising: credit card, debit card, electronically stored credit account information, electronically stored debit account information.

11. The method of claim 8, 9 or 10 further comprising the step of electronically receiving funds on behalf of said customer.

12. The method of claim 1 further comprising the step of:
upon said customer's attendance at said specific merchant location for fulfillment of said initial order, obtaining from said customer a signature to a contract reflecting the terms of future transactions between said customer and said remote ordering system.

13. The method of claim 12 wherein said signature is a digital signature or a manuscript signature.

14. The method of claim 12 wherein said step of activating comprises the steps of:
receiving confirmation that said signature has been obtained from said customer;
authorizing said activation of said customer account; and,
activating said customer account upon said authorization.

15. A method for establishing a customer account in an electronic remote ordering system wherein order fulfillment is accomplished upon the customer's attendance at a merchant location, comprising:
accepting an order from a customer at a point of sale terminal;
while said customer is still at the point of sale terminal, inviting said customer to establish a remote ordering customer account, said invitation including collecting identifying information from said customer; and,
upon said customer providing said identifying information, capturing details of said order from said point of sale terminal, combining said details with said identifying information, and identifying said order as an optional remote ordering customer preference for said customer.

16. The method of claim 15 wherein said identifying information comprises a telephone number.

17. The method of claim 16 wherein said identifying information consists exclusively of said telephone number.

18. The method of claim 15 or 17 further comprising the step of communicating said identifying information and said details to said electronic remote ordering system and establishing a customer account for said electronic remote ordering system based on said identifying information and said details.

19. A remote ordering system for use by at least one customer in placing an order for fulfillment at one of a plurality of affiliated merchants, said merchants operating a plurality of different merchant locations, comprising one or more servers for receiving and processing an order from said customer, said order identifying a specific one of said merchant locations for fulfillment of said order, and for transmitting said order to said specific one of said merchant locations for fulfillment by said specific merchant location, and a database associated with said one or more servers, said database comprising information specific to each of said merchant locations.

20. A method for establishing a customer account in an electronic remote ordering system used in association with a chain of associated vendor outlets and wherein order fulfillment is accomplished upon the customer's attendance at a customer-specified merchant location, said remote ordering system comprising a database associating each outlet in said said with product fulfillment capabilities, said method comprising:
creating a customer account in said remote ordering system contemporaneous with said customer placing an initial order through said remote ordering system for fulfillment at a specific merchant location;
delivering said initial order from said remote ordering system to said specific merchant location; and,
activating said customer account upon or after said customer's attendance at said specific merchant location for fulfillment of said initial order.

21. The method of claim 1 further comprising the step of:
upon said customer's attendance at said specific merchant location for fulfillment of said initial order, verifying the customer's identity.

22. The method of claim 7 wherein said step of collecting further information comprises deriving said further information from a marketing database containing information identifying a plurality of potential customers.
